(19) United States
(12) Patent Application Publication
(10) Pub. No.: US 2005/0233241 A1
(43) Pub. Date: Oct. 20, 2005

(54) Materials and method for backprinting imaging media

(75) Inventors: Peter T. Aylward, Hilton, NY (US); James S. Honan, Spencerport, NY (US); Narasimharao Dontula, Rochester, NY (US)

Correspondence Address: Paul A. Leipold, Patent Legal Staff,;Eastman Kodak Company, 343 State Street, Rochester, NY, 14650-2201, US

(73) Assignee: Eastman Kodak Company

(21) Appl. No.: 10/827,398

(22) Filed: Apr. 19, 2004

(51) Int. Cl. G03C 8/00; B41M 5/20

(52) U.S. Cl. 430/126; 430/199; 503/227

(57) ABSTRACT

The present invention relates to a method for placing indicia on the non-image side of a support for an imaging element comprising providing a support, which has an image side having at least one imaging layer and a non-image side, contacting the non-image side of the support with a thermal transfer donating sheet, applying energy in a pattern to the thermal transfer dye donating sheet, and transferring the pattern to the non-image side of the support to form indicia.

### FIELD OF THE INVENTION

The present invention relates to thermal dye transfer and electrophotographic materials and methods for backprinting imaging media such as resin coated paper, flange coated low density core, and film based products.

### BACKGROUND OF THE INVENTION

Imaging materials such as photographic supports, and thermal dye transfer, electrophotographic and ink jet receiver materials, are typically provided with an imaging layer on one side and the opposite side of the imaging element, the non-image side, is not typically provided with an imaging layer. Rather, the imaging elements are commonly printed with indicia on the non-image side of their support substrates for the purpose of communicating brand, logo, media type, and other information. However, such imaging materials have substrates that are not easily provided with printing on the back of the substrate, especially if multiple colors or multiple inks are desired. The indicia must also be protected from scratching and exposure, especially to light and or chemicals such as photo-processing solutions.

A photographic paper commercially available has a single color printed logo or other brand information printed on the base paper that forms the back of the photographic element. This logo is coated with a layer of polyethylene that provides protection from scratching and photo-processing chemicals. The present product is practically limited to a single ink because the present production machines are limited by cost and space limitations to a single color press for printing the indicia onto the back of the base paper. In traditional imaging supports, the print indicia is printed onto the paper web that then is plastic coated or laminated with a biaxially oriented polymer sheet or is printed on a biaxially oriented sheet on the side in contact the paper or base substrate. The print indicia are typically applied by a Flexographic printing, or Rotogravure printing process. The Rotogravure method of printing uses a print cylinder with thousands of tiny cells that are below the surface of the printing cylinder. The ink is transferred from the cells when the print cylinder is brought into contact with the web at the impression roll.

U.S. Pat. Nos. 5,874,205, and 6,007,665 describe imaging elements where indicia are provided on a surface of a biaxially oriented polymer sheet laminated to a paper base with the indicia on the surface of the polymer sheet between the polymer sheet and the paper base. The indicia are protected from abrasion and chemical exposure by the layer of biaxially oriented polymer sheet. The indicia are described as being mono-color or multicolor where the inks are applied via flexographic printing, rotogravure printing or digital printing. The digital printing methods include ink-jet printing and thermal dye transfer printing. Also disclosed is that the indicia could be printed on the outer surface of the biaxially oriented polymer sheet, such as after formation or processing of a photographic paper.

U.S. Pat. No. 5,434,596 describes a method of providing quarter-toned indicia through thermal printing on the back of an image bearing sheet, such as a photograph, however no provision is made for printing multiple color indicia or protecting the indicia from abrasion and chemical exposure, as this technique is directed at providing indicia during photo-finishing. Although it provides for reduced backprint shadows, where the indicia on the backside can be observed through the image when viewing from the image bearing side, the image quality of the indicia is necessarily and undesirably reduced.

Efforts to improve imaging media to provide for increased versatility in their application to various imaging technologies, reduced complexity of manufacturing such media, and an increased ability to recycle imaging media have resulted in new structures that increase the complexity of providing indicia on the backside of the media. U.S. Pat. No. 6,537,656, U.S. Pat. No. 6,447,976, U.S. Pat. No. 6,447,976, U.S. Pat. No. 6,514,659, and EP 1,326,135 describe an imaging member with a base composed of a closed cell foam core with flange layers adhered to the upper and lower surfaces of the foam core. In particular, it would be desirable to have a means of providing indicia on the back most layer of a pigmented flange coated foam core base. When there is pigment in the back-side flange layer, printing under the somewhat opaque flange is difficult because the indicia would have to be printed at a high enough density to be visible through the flange, resulting in the indicia being observable in the image when viewing from the image bearing side. In this type of imaging element it would be desirable to have ink that can be printed on the outer most flange layer. This provides much better image quality of the print. On the other hand, since the print is open to the environment it can be subjected to abrasion, chemical processing problems and fading when exposed to light. It would be desirable to have a print that can be protected against environmental abuses.

### PROBLEM TO BE SOLVED

There is a need for a reliable, low cost, and high quality method of printing multicolor information and illustrations on the back of imaging materials, particularly flange coated foam core sheets, more particularly for silver halide imaging media and inkjet media using flange coated foam core sheets.

### SUMMARY OF THE INVENTION

The present invention relates to a method for placing indicia on the non-image side of a support for an imaging element comprising providing a support, which has an image side having at least one imaging layer and a non-image side, contacting the non-image side of the support with a thermal transfer donating sheet, applying energy in a pattern to the thermal transfer dye donating sheet, and transferring the pattern to the non-image side of the support to form indicia.

### ADVANTAGEOUS EFFECT OF THE INVENTION

The invention has numerous advantages over practices in the prior art, not all of which may be incorporated into a single embodiment. The provision of a multicolor high quality image of the back of a photographic paper allows the paper to communicate brand information. The back may be decorated with material that will identify the paper with a particular event such as the Olympics or a sports team. The back of the photographic paper could also be used as advertising medium or personalized for particular photographers or developing laboratories. The back of the photographic image could further be supplied with copyright information to inform customers of their obligations under the copyright laws if any. The back of the photographic image may be used to print customer specified information e.g. details of the scene. The invention also eliminates the need to dry the print on the base paper as the indicia is carried by an additional sheet and, therefore, does not require drying during formation of the photographic sheet.

### DETAILED DESCRIPTION OF THE INVENTION

The present invention provides a method of placing indicia on the non-image side of a support by providing a support, contacting the non-image side of the support with a thermal transfer dye donating sheet, applying energy in a pattern to the thermal transfer dye donating sheet to produce indicia matching the pattern on the non-image side of the support.

Elements utilized with the present invention may contain multiple layers. For these multilayer structures, the terms as used herein, “top”, “upper”, and “above” mean the layer that is farther from the support in relation to the relative positioning with respect to the other layers. The terms “bottom” “lower” and “below” mean the layer that is closer to the support in relation to the relative positioning with respect to the other layers. The “image side” of the support is the side on which imaging layers would be applied. The “non-image side” of the support is the side of the support opposite the imaging layers, and may also be referred to as the back surface, or the backside of the imaging element or imaging support. The terms overcoat, overcoat protection layer, overcoat protection laminate or auxiliary layers may also be referred to as an environmental protection layer. Such a layer or layers may be added to protect the indicia dyes from a variety of conditions that may cause them to degrade or be less visible or desirable to the end user.

The imaging element utilized in the instant invention is preferably printed on the back most side that is exposed to the environment. The backside of the imaging support preferably is a thermoplastic polymer that is extrusion coated onto a substrate, such as paper, plastic film, cloth or foam core that has been flange coated. A thermal transfer process preferably accomplishes this printing. Thermal transfer printing preferably uses a digital computer file of the indicia to be printed. The use of digital printing provides a unique way to impart indicia onto the backside of the imaging element, allowing flexibility and customization of the indicia to be printed. The printing is accomplished by the transfer of the dye from a donor sheet surface onto the backside of the imaging support.

While typical thermal transfer processes require a dye receiving layer to provide a good stable image, the advantage of this invention is that the dye transfer indicia may be transferred directly to the backside of the substrate, that is, the non-image side of the imaging element for use in the present invention, without a special dye receiving layer. However, it may be desirable to include a dye-receiver layer for other purposes. Typical dye image-receiving layer may comprise, for example, a polycarbonate, a polyurethane, a polyester, poly(vinyl chloride), poly(styrene-co-acrylonitrile), polycaprolactone or mixtures thereof. The dye image-receiving layer may be present in any amount that is effective for the intended purpose. In general, good results have been obtained at a concentration of from about 1 to about 5 g/m². The imaging elements of the invention may comprise an antistatic layer on the backside of the element. When the indicia is applied to the antistatic layer, the binder of the antistatic layer can act as a dye receiving layer. In one embodiment, the components of the dye receiving layer may be the flange layer of the imaging support.

The indicia placed on the non-image side of the support utilized in the present invention comprise at least one member selected from the group consisting of letters, pictures, numbers, symbols, patterns and words. The indicia may be bar codes, logos, or photographic images. The indicia may be printed in regular patterns, such as a grid pattern or regularly spaced logos, or they may be randomly placed. The indicia may provide promotional or informational messages.

Thermal transfer indicia may be obtained electronically digital files, such as those obtained from a color video camera or computer graphics. According to one way of obtaining such prints, an electronic picture is first subjected to color separation by color filters. The respective color-separated images are then converted into electrical signals. These signals are then operated on to produce cyan, magenta and yellow electrical signals. These signals are then transmitted to a thermal printer. To obtain the print, a cyan, magenta or yellow thermal dye-donating sheet is placed face-to-face with the non-image side of an element utilized with the present invention, which is functioning to receive indicia. The two are then inserted between a thermal printing head and a platen roller. A line-type thermal printing head is used to apply heat from the back of the dye-donor sheet. The thermal printing head has many heating elements and is heated up sequentially in response to the cyan, magenta and yellow signals. The process is then repeated for the other two colors. A color or monochromic indicia is thus obtained which corresponds to the original. Further details of this process and an apparatus for carrying it out are contained in U.S. Pat. No. 4,621,271, the disclosure of which is hereby incorporated by reference.

To transfer the pattern to form the indicia, energy is applied to the thermal dye donating sheet utilized in the present invention. In a preferred embodiment, the energy comprises heat energy. In another preferred embodiment, the energy comprises laser energy. Such a process comprises imagewise heating a thermal dye-donating sheet and transferring a dye indicia to the non-image side of the imaging element used in the present invention to form the dye transfer indicia. After the dye indicia is transferred, the protection layer is then transferred on top of the dye image.

The thermal dye-donating sheet includes a dye-donor layer. The dye-donor layer may include one or more areas (patches), preferably colored, containing dyes suitable for thermal printing. As used herein, a “dye” can be one or more dye, pigment, colorant, or a combination thereof, and can optionally be in a binder or carrier as known to practitioners in the art. During thermal printing, at least a portion of one or more colored areas is be transferred to the backside of the imaging element, forming a colored image on the backside of the imaging element.

During thermal printing, the entire laminate area may be transferred to the backside of the imaging element. The dye-donor layer may include one or more colored areas and one or more laminate areas. For example, the dye-donor layer may include three color patches, for example, yellow, magenta, and cyan.

Any dye transferable by heat may be used in the dye-donor layer of the thermal dye-donating sheet. For example, sublimable dyes may be used, such as but not limited to anthraquinone dyes, such as Sumikalon Violet RS® (product of Sumitomo Chemical Co., Ltd.), Dianix Fast Violet 3R-FS® (product of Mitsubishi Chemical Corporation.), and Kayalon Polyol Brilliant Blue N-BGM® and KST Black 146® (products of Nippon Kayaku Co., Ltd.), azo dyes such as Kayalon Polyol Brilliant Blue BM®, Kayalon Polyol Dark Blue 2BM®, and KST Black KR® (products of Nippon Kayaku Co., Ltd.), Sumickaron Diazo Black 5G® (product of Sumitomo Chemical Co., Ltd.), and Miktazol Black 5GH® (product of Mitsui Toatsu Chemicals, Inc.), direct dyes such as Direct Dark Green B® (product of Mitsubishi Chemical Corporation) and Direct Brown M® and Direct Fast Black D® (products of Nippon Kayaku Co. Ltd.), acid dyes such as Kayanol Milling Cyanine 5R® (product of Nippon Kayaku Co. Ltd.), and basic dyes such as Sumicacryl Blue 6G (product of Sumitomo Chemical Co., Ltd.), and Aizen Malachite Greeng (product of Hodogaya Chemical Co., Ltd.), magenta dyes of the structures 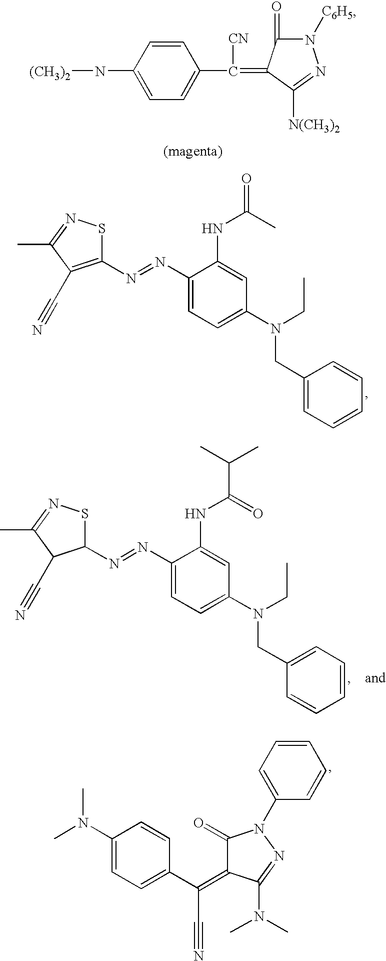
cyan dyes of the structures 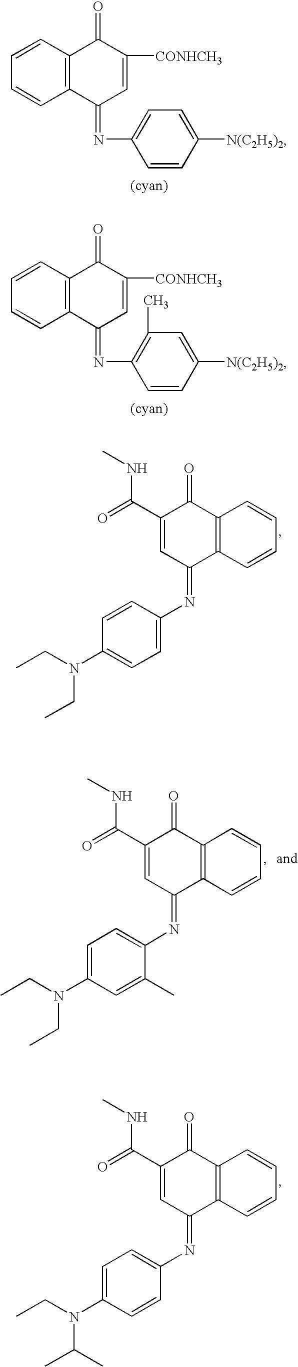
and yellow dyes of the structures

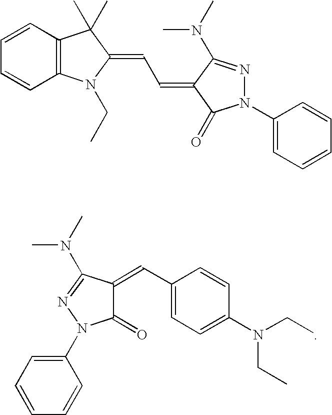

Other examples of dyes are set forth in U.S. Pat. No. 4,541,830, and U.S. Pat. No. 5,332,713 and are known to practitioners in the art. The dyes may be employed singly or in combination to obtain a monochrome dye-donor layer. The dyes may be used in an amount of from about 0.05 g/m² to about 1 g/m² of coverage. According to various embodiments, the dyes may be hydrophobic.

The dye-donor layer may have a dye to binder ratio for each color dye patch. For example, a yellow dye to binder ratio may be from about 0.3 to about 1.2, or from about 0.5 to about 1.0. A magenta dye to binder ratio may be from about 0.5 to about 1.5, or from about 0.8 to about 1.2. A cyan dye to binder ratio may be from about 1.0 to about 2.5, or from about 1.5 to about 2.0.

To form a dye-donor layer, one or more dyes may be dispersed in a polymeric binder, for example, a polycarbonate, a poly(styrene-co-acrylonitrile), a poly(sulfone), a poly(phenylene oxide), a cellulose derivative such as but not limited to cellulose acetate hydrogen phthalate, cellulose acetate, cellulose acetate propionate, cellulose acetate butyrate, or cellulose triacetate, or a combination thereof. The binder may be used in an amount of from about 0.05 g/m² to about 5g/m^{2.}

Optionally, release agents as known to practitioners in the art may also be added to the thermal dye-donating sheet, for example, to the dye-donor layer, the slip layer, or both. Suitable release agents include those described in U.S. Pat. Nos. 4,740,496 and 5,763,358.

The thermal dye-donating sheet may be a sheet of one or more colored patches or laminate, or a continuous roll or ribbon. The continuous roll or ribbon may include one patch of a monochromatic color or laminate, or may have alternating areas of different patches, for example, one or more dye patches of cyan, magenta, yellow, or black, one or more laminate patches, or a combination thereof.

The dye-donor layer of the thermal dye-donating sheet may be formed or coated on a support. The dye-donor layer may be formed on the support by a printing technique such as but not limited to a gravure process, spin-coating, solvent-coating, extrusion coating, or other methods known to practitioners in the art.

The method of using a donor sheet provides a means to further apply materials to the ink that will protect it. By using a donor web to transfer the indicia to the backside of an imaging element, at least one environmental protection laminate area, also referred to herein as an environmental protection layer, may be applied to the indicia. The laminate area may cover the entire transfer sheet or over only areas of the transfer sheet and transfer of the protection area may correspond accordingly. The laminate area may follow one or more colored areas. Preferably, this layer is clear or transparent. Some useful materials for the environmental protection layer may include poly(vinyl formal), poly(vinyl benzal) or poly(vinyl acetal). Other materials may include silica, wax, vinyl chloride, vinyl acetate, acrylic resin, styrene, epoxy, polyester resin, epoxy resin, cellulose acetate resin, nylon resin, and polyvinylpyrrolidone resin.

The donor layer may also include a clear laminate patch, for forming a three color image with a protective laminate layer on a backside of the imaging element. The protection layer may also contain image dyes to reduce the number of patches to be printed to the backside of the imaging element, and be used alone as the dye supplying patch or in combination with patches containing only sublimable dye. An alternative embodiment of the invention provides a multilayer dye-donating sheet in which the protection layer is on the support, and a dye layer is on the protection layer, such that when the protection layer is transferred to the backside of the imaging element, the dye image is between the back surface of the imaging element and the environmental protection layer. If a protective overcoat layer is applied to the thermal print by uniform application of heat using a thermal head, after transfer to the thermal print, the protection layer provides superior protection against image deterioration due to exposure to light, photographic processing chemicals as well as many other household chemicals, such as grease and oil from fingerprints, and plasticizers from film album pages or sleeves made of poly(vinyl chloride). The protection layer may be generally applied in a concentration of at least about 0.05 g/m². Compositions of environmental protection layers suitable for use in the invention may be found in U.S. Pat. No. 5,387,573.

If the sublimable dyes are transferred to a layer of polyolefin such as melt extruded polypropylene or oriented polypropylenes, and the transferred dyes are exposure to acid and highly basic chemicals, such as photoprocessing chemicals, the unprotected dyes may react with these chemicals to cause the dyes to fade or otherwise be removed. The further addition of the environmental protection layer provides good protection. Suitable materials for use in a photoprocessing chemical protection layer may include hydrophobic polymers, such as acrylates, acrylics, polystyrenes, vinyls and copolymers thereof. One preferred photoprocessing chemical protection layer comprises a blend of hydrophobic polymer such as polyvinyl acetal and polyvinyl butyral. In another embodiment, the photochemical material protection laminate area may comprise colloid silica and UV absorbing material.

Imaging elements such as inkjet, thermal dye transfer or electrophotographic receivers, as well as silver halide imaging elements provided with indicia on the backside according to the present invention may be provided with protection of the indicia from abrasion as well as light exposure. In the case where abrasion resistance is desirable, a layer of polymer or filled polymer may be applied to the print. Such materials may include acrylate, vinyl, acrylic and styrene based polymers. Particles such as silica or microbeads may be added to minimize contact against the backside indicia. The materials may contain slip agents or fluopolymers that minimize the coefficient of friction as the imaging element is conveyed over various surfaces. Preferred abrasion protection materials may include microbeads, slip agents and fluoropolymers.

To provide for protection from light exposure, the environmental protection layer may contain ultraviolet absorbing materials. These materials may be UV absorbing dyes or particles of ZnO or TiO2, preferably nano-particles. When abrasion or light protection materials are used, it is desirable to minimize the opacity of the protecting layer to maintain viewing clarity of the indicia. In the case of silver halide, the environmental protection layer may provide protection of the indicia during processing from photochemical materials, for example, acid and alkaline solutions. If the indicia is not protected the dye may smear, fade or be easily rubbed off. Furthermore, the dyes may contaminate the processing solutions and in turn affect the image development of the image side.

The thermal dye-donating sheet may also include a slip layer capable of preventing the printing head from sticking to the thermal dye-donating sheet. The slip layer may be coated on a side of the support opposite the dye-donor layer. The slip layer may include a lubricating material, for example, a surface-active agent, a liquid lubricant, a solid lubricant, or mixtures thereof, with or without a polymeric binder. Suitable lubricating materials may include oils or semi-crystalline organic solids that melt below 100° C., for example, poly(vinyl stearate), beeswax, perfluorinated alkyl ester polyether, poly(caprolactone), carbowax, polyethylene homopolymer, or poly(ethylene glycol). Suitable polymeric binders for the slip layer may include poly(vinyl alcohol-co-butyral), poly(vinyl alcohol-co-acetal), poly(styrene), poly(vinyl acetate), cellulose acetate butyrate, cellulose acetate, ethyl cellulose, and other binders as known to practitioners in the art. The amount of lubricating material used in the slip layer is dependent, at least in part, upon the type of lubricating material, but may be in the range of from about 0.001 to about 2 g/m², although less or more lubricating material may be used as needed. If a polymeric binder is used, the lubricating material may be present in a range of 0.1 to 50 weight %, preferably 0.5 to 40 weight %, of the polymeric binder.

The imaging support utilized in the imaging elements for use with present invention may be any support commonly used in imaging elements. The support for the thermal dye-donating sheet may be formed of any material capable of withstanding the heat of thermal printing. According to various embodiments, the support may be dimensionally stable during printing. Suitable materials may include polyesters, for example, poly(ethylene terephthalate), polyamides, polycarbonates, glassine paper, condenser paper, cellulose esters, for example, cellulose acetate, fluorine polymers, for example, polyvinylidene fluoride, and poly(tetrafluoroethylene-cohexafluoropropylene), polyethers, for example, polyoxymethylene, polyacetals, polyolefins, for example, polystyrene, polyethylene, polypropylene, and methylpentane polymers, polyimides, for example, polyimide-amides and polyether-imides, and combinations thereof. The support may have a foam core, with or without flange layers, or a voided core. The support used in the invention may have a thickness of from about 50 to about 500 μm, preferably from about 75 to 350 μm. The most preferred supports comprise paper, resin coated paper, a closed cell foam core sheet having adhered thereto an upper and lower polymer flange sheet, and wherein said closed cell foam core sheet comprises an expanded polymer and a blowing agent. In a preferred embodiment, the support further comprises at least one biaxially oriented, voided sheet.

The support may be either opaque or transparent. Opaque supports include plain paper, coated paper, resin-coated paper such as polyolefin-coated paper, synthetic paper, photographic paper support, melt-extrusion-coated paper, and polyolefin-laminated paper, such as biaxially oriented support laminates. The support may also consist of microporous materials such as polyethylene polymer-containing material sold by PPG Industries, Inc., Pittsburgh, Pa. under the trade name of Teslin®, Tyvek® synthetic paper (DuPont Corp.), impregnated paper such as Duraform®, and OPPalyte® films (Mobil Chemical Co.) and other composite films listed in U.S. Pat. No. 5,244,861. Transparent supports include glass, cellulose derivatives, such as a cellulose ester, cellulose triacetate, cellulose diacetate, cellulose acetate propionate, cellulose acetate butyrate, polyesters, such as poly(ethylene terephthalate), poly(ethylene naphthalate), poly-1,4-cyclo-hexanedimethylene terephthalate, poly(butylene terephthalate), and copolymers thereof, polyimides, polyamides, polycarbonates, polystyrene, polyolefins, such as polyethylene or polypropylene, polysulfones, polyacrylates, polyether imides, and mixtures thereof. The papers listed above include a broad range of papers, from high end papers, such as photographic paper to low end papers, such as newsprint. In a preferred embodiment, Ektacolor paper made by Eastman Kodak Co. is employed. The term as used herein, “transparent” means the ability to pass radiation without significant deviation or absorption. The support used in the invention may have a thickness of from about 50 to about 500 μm, preferably from about 75 to 350 μm. Antioxidants, brightening agents, antistatic agents, plasticizers and other known additives may be incorporated into the support, if desired.

In a preferred embodiment, the support comprises a synthetic paper having a polymer foam core that has adhered thereto an upper and a lower flange sheet. The polymer foam core comprises a homopolymer such as a polyolefin, polystyrene, polyvinylchloride or other typical thermoplastic polymers, their copolymers or their blends thereof, or other polymeric systems like polyurethanes, polyisocyanurates that has been expanded through the use of a blowing agent to consist of two phases, a solid polymer matrix, and a gaseous phase. Other solid phases may be present in the foams in the form of fillers that are of organic (polymeric, fibrous) or inorganic (glass, ceramic, metal) origin. The fillers may be used for physical, optical (lightness, whiteness, and opacity), chemical, or processing property enhancements of the foam.

The foaming of these polymers may be carried out through several mechanical, chemical, or physical means. Mechanical methods include whipping a gas into a polymer melt, solution, or suspension, which then hardens either by catalytic action or heat or both, thus entrapping the gas bubbles in the matrix. Chemical methods include such techniques as the thermal decomposition of chemical blowing agents generating gases such as nitrogen or carbon dioxide by the application of heat or through exothermic heat of reaction during polymerization. Physical methods include such techniques as the expansion of a gas dissolved in a polymer mass upon reduction of system pressure, the volatilization of low-boiling liquids such as fluorocarbons or methylene chloride, or the incorporation of hollow microspheres in a polymer matrix. The choice of foaming technique is dictated by desired foam density reduction, desired properties, and manufacturing process.

In a preferred embodiment of this invention polyolefins such as polyethylene and polypropylene, their blends and their copolymers are used as the matrix polymer in the foam core along with a chemical blowing agent such as sodium bicarbonate and its mixture with citric acid, organic acid salts, azodicarbonamide, azobisformamide, azobisisobutyrolnitrile, diazoaminobenzene, 4,4′-oxybis(benzene sulfonyl hydrazide) (OBSH), N,N′-dinitrosopentamethyltetramine (DNPA), sodium borohydride, and other blowing agent agents well known in the art. The preferred chemical blowing agents would be sodium bicarbonate/citric acid mixtures, azodicarbonamide, though others may also be used. These foaming agents may be used together with an auxiliary foaming agent, nucleating agent, and a cross-linking agent.

The flange sheets are chosen to satisfy specific requirements of flexural modulus, caliper, surface roughness, and optical properties such as colorimetry and opacity. The flange members may be formed integral with the foam core by manufacturing the foam core with a flange skin sheet or the flange may be laminated to the foam core material. The integral extrusion of flange members with the core is preferred for cost. The lamination technique allows a wider range of properties and materials to be used for the skin materials. Imaging elements are constrained to a range in stiffness and caliper. At stiffness below a certain minimum stiffness, there is a problem with the element in print stackability and print conveyance during transport through photofinishing equipment, particularly high speed photoprocessors. It is believed that there is a minimum cross direction stiffness of 60 mN required for effective transport through photofinishing equipment. At stiffness above a certain maximum, there is a problem with the element in cutting, punching, slitting, and chopping during transport through photofinishing equipment. It is believed that there is a maximum machine direction stiffness of 300 mN for effective transport through photofinishing equipment. It is also desirable for transport reasons through photofinishing equipment that the caliper of the imaging element most preferably be constrained between 75 μm and 350 μm.

Preferred ranges of foam core caliper and modulus and flange caliper and modulus follow: the preferred caliper of the foam core of the invention ranges between 200 μm and 350 μm, the caliper of the flange sheets of the invention ranges between 10 μm and 175 μm, the modulus of the foam core of the invention ranges between 30 MPa and 1000 MPa, and the modulus of the flange sheets of the invention ranges from 700 MPa to 10500 MPa. In each case, the above range is preferred because of (a) consumer preference, (b) manufacturability, and (c) materials selection. It is noted that the final choice of flange and core materials, modulus, and caliper will be a subject of the target overall element stiffness and caliper.

In one embodiment of this invention, the flange sheets used comprise paper. The paper may be made on a standard continuous fourdrinier wire machine or on other modern paper formers. Any pulps known in the art to provide paper may be used in this invention. Bleached hardwood chemical kraft pulp is preferred, as it provides brightness, a good starting surface, and good formation while maintaining strength. Paper flange sheets useful to this invention are of caliper between about 10 μm and about 175 μm, preferably between about 30 μm and about 70 μm because then the overall element thickness and stiffness is in the range preferred by customers for imaging element and processes in existing equipment.

They are desired to be “smooth” as to not interfere with the viewing of images. Chemical additives to impart hydrophobicity (sizing), wet strength, and dry strength may be used as needed. Inorganic filler materials such as TiO2, talc, CaCO3, and clays may be used to enhance optical properties and reduce cost as needed. Dyes, biocides, and processing chemicals may also be used as needed. The paper may also be subject to smoothing operations such as dry or wet calendering, as well as to coating through an in-line or an off-line paper coater.

The flange sheets used may also comprise high modulus polymers such as high density polyethylene, polypropylene, or polystyrene, their blends or their copolymers, that have been stretched and oriented. They may be filled with suitable filler materials as to increase the modulus of the polymer and enhance other properties such as opacity and smoothness. Some of the commonly used inorganic filler materials are talc, clays, calcium carbonate, magnesium carbonate, barium sulfate, mica, aluminum hydroxide (trihydrate), wollastonite, glass fibers and spheres, silica, various silicates, and carbon black. Some of the organic fillers used are wood flour, jute fibers, sisal fibers, or polyester fibers. The preferred fillers are talc, mica, and calcium carbonate because they provide excellent modulus enhancing properties. Polymer flange sheets useful to this invention are of caliper between about 10 μm and about 175 μm, preferably between about 30 μm and about 70 μm.

The foam support, while described as having preferably at least three layers of a foam core and a flange layer on each side, may also be provided with additional layers that may serve to change the properties of the support. The foam support may be coated or treated after the coextrusion and orienting process or between casting and full orientation with any number of coatings which can be used to improve the properties of the sheets including to provide a vapor barrier, to make them heat sealable, or to improve the adhesion to the support or to the photosensitive layers. Examples of this would be coating polyvinylidene chloride for heat seal properties. Further examples include flame, plasma, or corona discharge treatment to improve printability or adhesion.

The foam support may also be made through the extrusion laminating process. Extrusion laminating is carried out by bringing together the paper or polymeric flange sheets of the invention and the foam core with application of an adhesive between them, followed by their being pressed in a nip such as between two rollers. The adhesive may be applied to either the flange sheets or the foam core prior to their being brought into the nip. In a preferred form, the adhesive is applied into the nip simultaneously with the flange sheets and the foam core. The adhesive may be any suitable material that does not have a harmful effect upon the element. A preferred material is polyethylene that is melted at the time it is placed into the nip between the foam core and the flange sheet. Addenda may also be added to the adhesive layer. Any know material used in the art to improve the optical performance of the system can be used. The use of TiO2 is preferred. During the lamination process also, it is desirable to maintain control of the tension of the flange sheets in order to minimize curl in the resulting laminated support.

The foam support may also contain various other materials. These may include filler materials such as titanium dioxide and calcium carbonate and colorants, dyes and/or optical brighteners or other additives known to those skilled in the art. The fillers may be in the flange or an overcoat layer, such as polyethylene. Generally, base materials for color print imaging materials are white, possibly with a blue tint as a slight blue is preferred to form a preferred white look to whites in an image. Any suitable white pigment may be incorporated in the support such as, for example, titanium dioxide, zinc oxide, zinc sulfide, zirconium dioxide, white lead, lead sulfate, lead chloride, lead aluminate, lead phthalate, antimony trioxide, white bismuth, tin oxide, white manganese, white tungsten, and combinations thereof The preferred pigment is titanium dioxide. In addition, suitable optical brightener may be employed in the polyolefin layer including those described in Research Disclosure, Vol. No. 308, December 1989, Publication 308119, Paragraph V, page 998.

Additionally, the foam support of this invention may be used as a label. In such an application, an imaging element comprising the support may be formed in which there is an image receiving layer as well as an adhesive layer. The image may be formed in or on the image receiving layer by light sensitive silver halide, ink jet printing, thermal dye transfer, electrophotographic or printing inks by a variety of techniques such as gravure or flexographic printing. There may be a need to provide additional smoothing layers or at least one overcoat protection layer on top of the image to further enhance the stability and durability of the image to a variety of environmental conditions. A variety of adhesives may be used including thermally activated, pressure sensitive, UV curables as well as repositionable adhesives. If the adhesive is pressure sensitive, a release liner would be helpful to cover the adhesive until the time of application to another surface. This would help to prevent unwanted dirt and other foreign materials from sticking to the adhesive layer. Additionally, it would be useful in providing a means for the adhesive and image to be wound in roll form without the adhesive sticking to the image side.

In addition, it may be desirable to use various additives such as antioxidants, slip agents, or lubricants, and light stabilizers in the plastic elements as well as biocides in the paper elements. These additives are added to improve, among other things, the dispersibility of fillers and/or colorants, as well as the thermal and color stability during processing and the manufacturability and the longevity of the finished article. For example, the polyolefin coating can contain antioxidants such as 4,4′-butylidene-bis(6-tert-butyl-meta-cresol), di-lauryl-3,3′-thiopropionate, N-butylated-p-aminophenol, 2,6-di-tert-butyl-p-cresol, 2,2-di-tert-butyl-4-methyl-phenol, N,N-disalicylidene-1,2-diaminopropane, tetra(2,4-tert-butylphenyl)-4,4′-diphenyl diphosphonite, octadecyl 3-(3′,5′-di-tert-butyl-4′-hydroxyphenyl propionate), or combinations of the above, heat stabilizers, such as higher aliphatic acid metal salts such as magnesium stearate, calcium stearate, zinc stearate, aluminum stearate, calcium palmitate, zirconium octylate, sodium laurate, and salts of benzoic acid such as sodium benzoate, calcium benzoate, magnesium benzoate and zinc benzoate, light stabilizers such as hindered amine light stabilizers (HALS), of which a preferred example is poly{[6-[(1,1,3,3-tetramethylbutylamino }-1,3,5-triazine-4-piperidinyl)-imino]-1,6-hexanediyl[{2,2,6,6-tetramethyl-4-piperdinyl)imino]}(Chimassorb 944 LD/FL).

In a preferred embodiment, the support comprises suitable biaxially oriented polyolefin sheets laminated to the core of the support to form a composite support. Suitable polyolefins include polypropylene, polyethylene, polymethylpentene, polystyrene, polybutylene and mixtures thereof. Polyolefin copolymers, including copolymers of propylene and ethylene such as hexene, butene, and octene are also useful. Polypropylene is preferred, as it is low in cost and has desirable strength properties.

The preferred biaxially oriented sheet is a biaxially oriented polyolefin sheet, most preferably a sheet of polyethylene or polypropylene. The thickness of the biaxially oriented sheet should be from 10 to 175 microns. Below 15 microns, the sheets cannot be thick enough to minimize any inherent non-planarity in the support and would be more difficult to manufacture. At thicknesses higher than 70 microns, little improvement in either surface smoothness or mechanical properties are seen, and so there is little justification for the further increase in cost for extra materials.

Suitable classes of thermoplastic polymers for the biaxially oriented sheet include polyolefins, polyesters, polyamides, polycarbonates, cellulosic esters, polystyrene, polyvinyl resins, polysulfonamides, polyethers, polyimides, polyvinylidene fluoride, polyurethanes, polyphenylenesulfides, polytetrafluoroethylene, polyacetals, polysulfonates, polyester ionomers, and polyolefin ionomers. Copolymers and/or mixtures of these polymers may be used.

Suitable polyolefins include polypropylene, polyethylene, polymethylpentene, and mixtures thereof. Polyolefin copolymers, including copolymers of propylene and ethylene such as hexene, butene and octene are also useful. Polypropylenes are preferred because they are low in cost and have good strength and surface properties.

Suitable polyesters include those produced from aromatic, aliphatic or cycloaliphatic dicarboxylic acids of 4-20 carbon atoms and aliphatic or alicyclic glycols having from 2-24 carbon atoms. Examples of suitable dicarboxylic acids include terephthalic, isophthalic, phthalic, naphthalene dicarboxylic acid, succinic, glutaric, adipic, azelaic, sebacic, fumaric, maleic, itaconic, 1,4-cyclohexanedicarboxylic, sodiosulfoisophthalic and mixtures thereof. Examples of suitable glycols include ethylene glycol, propylene glycol, butanediol, pentanediol, hexanediol, 1,4-cyclohexanedimethanol, diethylene glycol, other polyethylene glycols and mixtures thereof. Such polyesters are well known in the art and may be produced by well known techniques, for example, those described in U.S. Pat. Nos. 2,465,319 and 2,901,466. Preferred continuous matrix polyesters are those having repeat units from terephthalic acid or naphthalene dicarboxylic acid and at least one glycol selected from ethylene glycol, 1,4-butanediol and 1,4-cyclohexanedimethanol. Poly(ethylene terephthalate), which can be modified by small amounts of other monomers, is especially preferred. Other suitable polyesters include liquid crystal copolyesters formed by the inclusion of suitable amount of a co-acid component such as stilbene dicarboxylic acid. Examples of such liquid crystal copolyesters are those disclosed in U.S. Pat. Nos. 4,420,607, 4,459,402 and 4,468,510.

Useful polyamides include nylon 6, nylon 66, and mixtures thereof. Copolymers of polyamides are also suitable continuous phase polymers. An example of a useful polycarbonate is bisphenol-A polycarbonate. Cellulosic esters suitable for use as the continuous phase polymer of the composite sheets include cellulose nitrate, cellulose triacetate, cellulose diacetate, cellulose acetate propionate, cellulose acetate butyrate, and mixtures or copolymers thereof. Useful polyvinyl resins include polyvinyl chloride, poly(vinyl acetal), and mixtures thereof. Copolymers of vinyl resins may also be utilized.

The biaxially oriented sheet may be transparent for viewing objects through the back sheet or addenda may be added to the biaxially oriented sheet to color of these sheets. This would include any process which is known to improve, including adding a white pigment, such as titanium dioxide, barium sulfate, clay, or calcium carbonate. This would also include adding fluorescing agents which absorb energy in the UV region and emit light largely in the blue region, or other additives which would improve the physical properties of the sheet or the manufacturability of the sheet. Colorants may also be added to the back sheet.

The coextrusion, quenching, orienting, and heat setting of these biaxially oriented sheets may be effected by any process which is known in the art for producing oriented sheet, such as by a flat sheet process or a bubble or tubular process, as in, for example, U.S. Pat. No. 4,764,425. The flat sheet process involves extruding or coextruding the blend through a slit die and rapidly quenching the extruded or coextruded web upon a chilled casting drum so that the polymer component(s) of the sheet are quenched below their solidification temperature. The quenched sheet is then biaxially oriented by stretching in mutually perpendicular directions at a temperature above the glass transition temperature of the polymer(s). The sheet may be stretched in one direction and then in a second direction or may be simultaneously stretched in both directions. After the sheet has been stretched, it is heat set by heating to a temperature sufficient to crystallize the polymers while restraining to some degree the sheet against retraction in both directions of stretching.

The biaxially oriented sheet, while described as having preferably at least one layer, may also be provided with additional layers that can serve to change the properties of the biaxially oriented sheet. Different effects may be achieved by including additional layers. Such layers might contain tints, antistatic materials, or slip agents to produce sheets of unique properties. Biaxially oriented sheets could be formed with surface layers, referred to herein as skin layers, that would provide an improved adhesion, or look to the support and photographic element. The biaxially oriented extrusion could be carried out with as many as 10 layers if desired to achieve some particular desired property. The biaxially oriented sheet may be made with layers of the same polymeric material, or it may be made with layers of different polymeric composition. For compatibility, an auxiliary layer may be used to promote adhesion of multiple layers.

The biaxially oriented sheets of the invention preferably have a water vapor permeability that is less than 1.55×10⁻⁴ g/mm²/day/atm. This allows faster emulsion hardening during formation, as the laminated invention support does not transmit water vapor from the emulsion layers during coating of the emulsions on the support. The transmission rate is measured according to ASTM F1249.

By having at least one nonvoided skin on the microvoided core, the tensile strength of the sheet is increased and makes it more manufacturable. It allows the sheets to be made at wider widths and higher draw ratios than when sheets are made with all layers voided. Coextruding the layers further simplifies the manufacturing process.

The nonvoided skin(s) should thus be from 5 to 85% of the sheet, preferably from 15 to 70% of the thickness. The nonvoided skin layers of the composite sheet may be made of the same polymeric materials as listed above for the core matrix. The composite sheet may be made with skin(s) of the same polymeric material as the core matrix, or it may be made with skin(s) of different polymeric composition than the core matrix. For compatibility, an auxiliary layer may be used to promote adhesion of the skin layer to the core.

Addenda may be added to the core matrix and/or to the skins to improve the whiteness of these sheets. This would include any process which is known in the art including adding a white pigment, such as titanium dioxide, barium sulfate, clay, or calcium carbonate. This would also include adding fluorescing agents which absorb energy in the UV region and emit light largely in the blue region, or other additives which would improve the physical properties of the sheet or the manufacturability of the sheet. For photographic use, a white base with a slight bluish tint is preferred.

These biaxially oriented sheets may be coated or treated after the coextrusion and orienting process or between casting and full orientation with any number of coatings which can be used to improve the properties of the sheets including printability, to provide a vapor barrier, to make them heat sealable, or to improve the adhesion to the support or to the photo sensitive layers. Examples of this would be acrylic coatings for printability, coating polyvinylidene chloride for heat seal properties. Further examples include flame, plasma or corona discharge treatment to improve printability or adhesion.

Microvoided composite biaxially oriented sheets may also be utilized and are conveniently manufactured by coextrusion of the core and surface layers, followed by biaxial orientation, whereby voids are formed around void-initiating material contained in the core layer. Such composite sheets are disclosed in, for example, U.S. Pat. Nos. 4,377,616, 4,758,462 and 4, 632,869, the disclosure of which is incorporated for reference.

“Void” is used herein to mean devoid of added solid and liquid matter, although it is likely the “voids” contain gas. The void-initiating particles which remain in the finished packaging sheet core should be from 0.1 to 10 μm in diameter and preferably round in shape to produce voids of the desired shape and size. The size of the void is also dependent on the degree of orientation in the machine and transverse directions. Ideally, the void would assume a shape which is defined by two opposed and edge contacting concave disks. In other words, the voids tend to have a lens-like or biconvex shape. The voids are oriented so that the two major dimensions are aligned with the machine and transverse directions of the sheet. The Z-direction axis is a minor dimension and is roughly the size of the cross diameter of the voiding particle. The voids generally tend to be closed cells, and thus there is virtually no path open from one side of the voided-core to the other side through which gas or liquid can traverse.

The imaging element of this invention generally has a glossy surface, that is, a surface that is sufficiently smooth to provide excellent reflection properties. Prior art photographic paper uses polyethylene cast against a rough chill roll to create nonglossy surfaces. It has been found that by controlling the voiding process in the biaxially oriented sheets, an opalescent surface can be created. An opalescent surface is preferred because it provides a unique photographic appearance to a reflective product that is perceptually preferred by youth, children, and when utilized as an advertising media. The opalescent surface is achieved when the microvoids in the vertical direction are between 1 and 3 micrometers. By the vertical direction, it is meant the direction that is perpendicular to the plane of the imaging member. The thickness of the microvoids preferably is between 0.7 and 1.5 micrometers for best physical performance and opalescent properties. The preferred number of microvoids in the vertical direction is between 8 and 30. The desired opalescent surface is not created with less than 6 microvoids in the vertical direction. The optical appearance of the opalescent surface is not significantly improved when there are greater than 35 microvoids in the vertical direction.

The void-initiating material may be selected from a variety of materials and should be present in an amount of about 5 to 50% by weight based on the weight of the core matrix polymer. Preferably, the void-initiating material comprises a polymeric material. When a polymeric material is used, it may be a polymer that can be melt-mixed with the polymer from which the core matrix is made and be able to form dispersed spherical particles as the suspension is cooled down. Examples of this would include nylon dispersed in polypropylene, polybutylene terephthalate in polypropylene, or polypropylene dispersed in polyethylene terephthalate. If the polymer is preshaped and blended into the matrix polymer, the desired characteristic is the size and shape of the particles. Spheres are preferred and they can be hollow or solid. These spheres may be made from cross-linked polymers, which are members selected from the group consisting of an alkenyl aromatic compound.

Once the pattern has been applied to the non-imaging side of the support, additional layers may be applied onto the support. The imaging supports of the invention may comprise any number of auxiliary layers, for example, functional layers, provided that the auxiliary layers do not degrade the indicia image quality. Such auxiliary layers may include antistatic layers, back mark retention layers, tie layers or adhesion promoting layers, abrasion resistant layers, conveyance layers, barrier layers, splice providing layers, UV absorption layers, antihalation layers, optical effect providing layers, waterproofing layers.

In one embodiment, the patterned layer may be separately overcoated. Materials used as an overcoat are disclosed above. According to various embodiments, a subbing layer, for example, an adhesive or tie layer, a dye-barrier layer, or a combination thereof, may be coated between the support and the dye-donor layer. The adhesive or tie layer may adhere the dye-donor layer to the support. Suitable adhesives are known to practitioners in the art, for example, Tyzor TBT® from E.I. DuPont de Nemours and Company. The dye-barrier layer may include a hydrophilic polymer. The dye-barrier layer may provide improved dye transfer densities.

The imaging element utilized in the present invention comprises at least one imaging layer. Preferably, the imaging layer comprises photosensitive silver halide imaging layer, an inkjet imaging layer, a thermal imaging layer, or an electrophotographic imaging layer.

As used herein, the phrase “imaging element” is a material comprising an imaging support and at least one imaging layer. As used herein, the phrase “photographic element” is a material that utilizes photosensitive silver halide in the formation of images. The thermal dye image-receiving layer of receiving elements used with the invention may comprise, for example, a polycarbonate, a polyurethane, a polyester, polyvinyl chloride, poly(styrene-co-acrylonitrile), poly(caprolactone) or mixtures thereof. The dye image-receiving layer may be present in any amount which is effective for the intended purpose. In general, good results have been obtained at a concentration of from 1 to 10 g/m². An overcoat layer may be further coated over the dye-receiving layer, such as described in U.S. Pat. No. 4,775,657 of Harrison et al.

Thermal dye-donating sheets that are used with the present invention conventionally comprise a support having thereon a dye containing layer. Any dye may be used in the dye-donor employed in the invention provided it is transferable to a dye-receiving layer or the non-image side of an element used in the present invention which non-image side functions as a receiver sheet by the action of heat. Especially good results have been obtained with sublimable dyes. Dye donors applicable for use in the present invention are described, for example, in U.S. Pat. Nos. 4,916,112, 4,927,803 and 5,023,228.

As noted above, thermal dye-donating sheets are used to form a dye transfer image. Such a process comprises image-wise-heating a thermal dye-donating sheet and transferring a dye image to a dye-receiving element or non-image side of an element used in the present invention which non-image side functions as a receiver sheet as described above to form the dye transfer image.

In a preferred embodiment of the thermal dye transfer method of printing, a dye donor element may be employed which compromises a poly-(ethylene terephthalate) support coated with sequential repeating areas of cyan, magenta, and yellow dye, and the dye transfer steps are sequentially performed for each color to obtain a three-color dye transfer image. Of course, when the process is only performed for a single color, then a monochrome dye transfer image is obtained.

Thermal printing heads which may be used to transfer dye from thermal dye-donating sheets used with the invention are available commercially. There may be employed, for example, a Fujitsu Thermal Head (FTP-040 MCS001), a TDK Thermal Head F415 HH7-1089 or a Rohm Thermal Head KE 2008-F3. Alternatively, other known sources of energy for thermal dye transfer may be used, such as lasers as described in, for example, GB No. 2,083,726A.

A thermal dye transfer assemblage comprises (a) a thermal dye-donating sheet, and (b) a dye-receiving element or non-image side of an element used in the present invention which non-image side functions as a receiver sheet as described above, the element to receive the dye being in a superposed relationship with the thermal dye-donating sheet so that the dye layer of the donor element is in contact with the surface to receive the dye.

When a three-color image is to be obtained, the above assemblage may be formed on three occasions during the time when heat is applied by the thermal printing head. After the first dye is transferred, the elements are peeled apart. A second thermal dye-donating sheet (or another area of the donor element with a different dye area) may be then brought in register with the surface to receive the dye and the process repeated. The third color may be obtained in the same manner.

The electrographic and electrophotographic processes and their individual steps have been well described in detail in many books and publications. The processes incorporate the basic steps of creating an electrostatic image, developing that image with charged, colored particles (toner), optionally transferring the resulting developed image to a secondary substrate, and fixing the image to the substrate. There are numerous variations in these processes and basic steps, the use of liquid toners in place of dry toners is simply one of those variations.

The first basic step, creation of an electrostatic image, may be accomplished by a variety of methods. The electrophotographic process of copiers uses imagewise photodischarge, through analog or digital exposure, of a uniformly charged photoconductor. The photoconductor may be a single-use system, or it may be rechargeable and reimageable, like those based on selenium or organic photoreceptors.

In an alternate electrographic process, electrostatic images are created iono-graphically. The latent image may be created on dielectric (charge-holding) medium, either paper or film. Voltage may be applied to selected metal styli or writing nibs from an array of styli spaced across the width of the medium, causing a dielectric breakdown of the air between the selected styli and the medium. Ions are created, which form the latent image on the medium.

Electrostatic images, however generated, are developed with oppositely charged toner particles. For development with liquid toners, the liquid developer is brought into direct contact with the electrostatic image. Usually a flowing liquid is employed, to ensure that sufficient toner particles are available for development. The field created by the electrostatic image causes the charged particles, suspended in a nonconductive liquid, to move by electrophoresis. The charge of the latent electrostatic image is thus neutralized by the oppositely charged particles. The theory and physics of electrophoretic development with liquid toners are well described in many books and publications.

If a reimageable photoreceptor or an electrographic master is used, the toned image is transferred to paper (or other substrate). The paper may be charged electrostatically, with the polarity chosen to cause the toner particles to transfer to the paper. Finally, the toned image is fixed to the paper. For self-fixing toners, residual liquid may be removed from the paper by air-drying or heating. Upon evaporation of the solvent these toners form a film bonded to the paper. For heat-fusible toners, thermoplastic polymers are used as part of the particle. Heating both removes residual liquid and fixes the toner to paper.

The dye receiving layer or DRL (dye receiving layer) for ink jet imaging can be applied by any known methods. Such as solvent coating, or melt extrusion coating techniques. The DRL may be coated over the TL (tie layer) at a thickness ranging from 0.1-10 μm, preferably 0.5-5 μm. There are many known formulations which can be useful as dye receiving layers. The primary goal is that the DRL be compatible with the inks which it will be imaged so as to yield the desirable color gamut and density. As the ink drops pass through the DRL, the dyes are retained or mordanted in the DRL, while the ink solvents pass freely through the DRL and are rapidly absorbed by the TL. Additionally, the DRL formulation is preferably coated from water, exhibits adequate adhesion to the TL, and allows for easy control of the surface gloss.

For example, Misuda et al. in U.S. Pat. Nos. 4,879,166, 5,264,275, 5,104,730, 4,879,166, and Japanese patents 1,095,091, 2,276,671, 2,276,670, 4,267,180, 5,024,335, and 5,016,517 discloses aqueous based DRL formulations comprising mixtures of psuedo-bohemite and certain water soluble resins. Light, in U.S. Pat. Nos. 4,903,040, 4,930,041, 5,084,338, 5,126,194, 5,126,195, and 5,147,717 discloses aqueous-based DRL formulations comprising mixtures of vinyl pyrrolidone polymers and certain water-dispersible and/or water-soluble polyesters, along with other polymers and addenda. Butters et al. in U.S. Pat. Nos. 4,857,386 and 5,102,717 disclose ink-absorbent resin layers comprising mixtures of vinyl pyrrolidone polymers and acrylic or methacrylic polymers. Sato et al. in U.S. Pat. No. 5,194,317 and Higuma et al. in U.S. Pat. No. 5,059,983 disclose aqueous-coatable DRL formulations based on poly (vinyl alcohol). Iqbal, in U.S. Pat. No. 5,208,092, discloses water-based DRL formulations comprising vinyl copolymers which are subsequently cross-linked. In addition to these examples, there may be other known or contemplated DRL formulations which are consistent with the aforementioned primary and secondary requirements of the DRL, all of which fall under the spirit and scope of the current invention.

The preferred DRL is a 0.1-10 micrometers DRL which is coated as an aqueous dispersion of 5 parts alumoxane and 5 parts poly (vinyl pyrrolidone). The DRL may also contain varying levels and sizes of matting agents for the purpose of controlling gloss, friction, and/or finger print resistance, surfactants to enhance surface uniformity and to adjust the surface tension of the dried coating, mordanting agents, anti-oxidants, UV absorbing compounds, light stabilizers.

Although the ink-receiving elements as described above can be successfully used to achieve the advantages of the present invention, it may be desirable to overcoat the DRL for the purpose of enhancing the durability of the imaged element. Such overcoats may be applied to the DRL either before or after the element is imaged. For example, the DRL may be overcoated with an ink-permeable layer through which inks freely pass. Layers of this type are described in U.S. Pat. Nos. 4,686,118, 5,027,131, and 5,102,717. Alternatively, an overcoat may be added after the element is imaged. Any of the known laminating films and equipment can be used for this purpose. The inks used in the aforementioned imaging process are well known, and the ink formulations are often closely tied to the specific processes, that is, continuous, piezoelectric, or thermal. Therefore, depending on the specific ink process, the inks may contain widely differing amounts and combinations of solvents, colorants, preservatives, surfactants, humectants. Inks preferred for use in combination with the image recording elements are water-based, such as those currently sold for use in the Hewlett-Packard Desk Writer 560C printer. However, it is intended that alternative embodiments of the image-recording elements as described above, which may be formulated for use with inks which are specific to a given ink-recording process or to a given commercial vendor, fall within the scope of the present invention.

As used herein, the phrase “photographic element” is a material that utilizes photosensitive silver halide in the formation of images. The photographic elements may be black and white, single color elements or multicolor elements. Multicolor elements contain image dye-forming units sensitive to each of the three primary regions of the spectrum. Each unit may comprise a single emulsion layer or multiple emulsion layers sensitive to a given region of the spectrum. The layers of the element, including the layers of the image-forming units, may be arranged in various orders as known in the art. In an alternative format, the emulsions sensitive to each of the three primary regions of the spectrum may be disposed as a single segmented layer.

The photographic emulsions useful with this invention are generally prepared by precipitating silver halide crystals in a colloidal matrix by methods conventional in the art. The colloid is typically a hydrophilic sheet forming agent such as gelatin, alginic acid, or derivatives thereof.

The crystals formed in the precipitation step are washed and then chemically and spectrally sensitized by adding spectral sensitizing dyes and chemical sensitizers, and by providing a heating step during which the emulsion temperature is raised, typically from 40° C. to 70° C., and maintained for a period of time. The precipitation and spectral and chemical sensitization methods utilized in preparing the emulsions employed in the invention may be those methods known in the art.

Chemical sensitization of the emulsion typically employs sensitizers such as: sulfur-containing compounds, for example, allyl isothiocyanate, sodium thiosulfate and allyl thiourea, reducing agents, for example, polyamines and stannous salts, noble metal compounds, for example, gold, platinum, and polymeric agents, for example, polyalkylene oxides. As described, heat treatment is employed to complete chemical sensitization. Spectral sensitization is effected with a combination of dyes, which are designed for the wavelength range of interest within the visible or infrared spectrum. It is known to add such dyes both before and after heat treatment.

The silver halide emulsions utilized used with this invention may be comprised of any halide distribution. Thus, they may be comprised of silver chloride, silver bromide, silver bromochloride, silver chlorobromide, silver iodochloride, silver iodobromide, silver bromoiodochloride, silver chloroiodobromide, silver iodobromochloride, and silver iodochlorobromide emulsions. It is preferred, however, that the emulsions be predominantly silver chloride emulsions. By predominantly silver chloride, it is meant that the grains of the emulsion are greater than 50 mole percent silver chloride. Preferably, they are greater than 90 mole percent silver chloride, and optimally greater than 95 mole percent silver chloride.

The silver halide emulsions may contain grains of any size and morphology. Thus, the grains may take the form of cubes, octahedrons, cubo-octahedrons, or any of the other naturally occurring morphologies of cubic lattice type silver halide grains. Further, the grains may be irregular such as spherical grains or tabular grains. Grains having a tabular or cubic morphology are preferred.

The photographic elements of the invention may utilize emulsions as described in The Theory of the Photographic Process, Fourth Edition, T. H. James, Macmillan Publishing Company, Inc., 1977, pages 151-152. Reduction sensitization has been known to improve the photographic sensitivity of silver halide emulsions. While reduction sensitized silver halide emulsions generally exhibit good photographic speed, they often suffer from undesirable fog and poor storage stability.

The photographic elements of this invention may use emulsions doped with Group VIII metals such as iridium, rhodium, osmium, and iron as described in Research Disclosure, September 1994, Item 36544, Section I, published by Kenneth Mason Publications, Ltd., Dudley Annex, 12a North Street, Emsworth, Hampshire PO10 7DQ, ENGLAND. Additionally, a general summary of the use of iridium in the sensitization of silver halide emulsions is contained in Carroll, “Iridium Sensitization: A Literature Review,” Photographic Science and Engineering, Vol. 24, No. 6, 1980. A method of manufacturing a silver halide emulsion by chemically sensitizing the emulsion in the presence of an iridium salt and a photographic spectral sensitizing dye is described in U.S. Pat. No. 4,693,965. In some cases, when such dopants are incorporated, emulsions show an increased fresh fog and a lower contrast sensitometric curve when processed in the color reversal E-6 process as described in The British Journal of Photography Annual, 1982, pages 201-203.

A typical multicolor photographic element of the invention comprises the invention laminated support bearing a cyan dye image-forming unit comprising at least one red-sensitive silver halide emulsion layer having associated therewith at least one cyan dye-forming coupler, a magenta image-forming unit comprising at least one green-sensitive silver halide emulsion layer having associated therewith at least one magenta dye-forming coupler, and a yellow dye image-forming unit comprising at least one blue-sensitive silver halide emulsion layer having associated therewith at least one yellow dye-forming coupler. The element may contain additional layers, such as filter layers, interlayers, overcoat layers, subbing layers. The support of the invention may also be utilized for black and white photographic print elements.

Additional details on emulsion making useful in this invention are illustrated by Research Disclosure, Item 38957, cited above, particularly:
III. Emulsion washing,
IV. Chemical sensitization,
V. Spectral sensitization and desensitization,
VII. Antifoggants and stabilizers,
VIII. Absorbing and scattering materials,
IX. Coating and physical property modifying addenda, and
X. Dye image formers and modifiers.

Image dye-forming couplers may be included in the element such as couplers that form cyan dyes upon reaction with oxidized color developing agents which are described in such representative patents and publications as: U.S. Pat. Nos. 2,367,531, 2,423,730, 2,474,293, 2,772,162, 2,895,826, 3,002,836, 3,034,892, 3,041,236, 4,883,746 and “Farbkuppler—Eine Literature Ubersicht,” published in Agfa Mitteilungen, Band III, pp. 156-175 (1961). Preferably such couplers are phenols and naphthols that form cyan dyes on reaction with oxidized color developing agent. Also preferable are the cyan couplers described in, for instance, European Patent Application Nos. 491,197, 544,322, 556,700, 556,777, 565,096, 570,006, and 574,948.

Typical cyan couplers are represented by the following formulas: 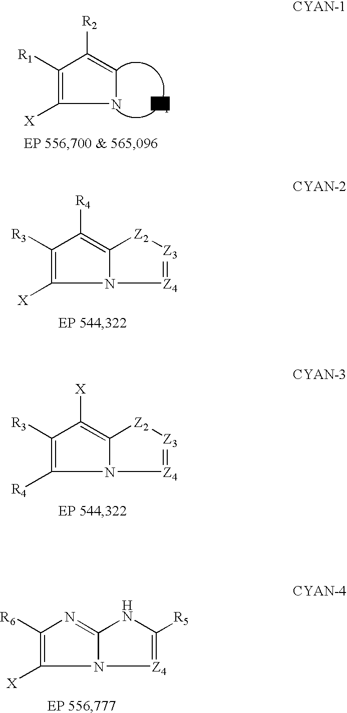
wherein R1, R5 and R8 each represents a hydrogen or a substituent, R2 represents a substituent, R3, R4 and R7 each represents an electron attractive group having a Hammett's substituent constant σp of 0.2 or more and the sum of the σp values of R3 and R4 is 0.65 or more, R6 represents an electron attractive group having a Hammett's substituent constant σp of 0.35 or more, X represents a hydrogen or a coupling-off group, Z1 represents nonmetallic atoms desirable for forming a nitrogen-containing, six-membered, heterocyclic ring which has at least one dissociative group, Z2 represents —C(R7)= and —N═, and Z3 and Z4 each represents —C(R8)= and —N═.

Even more preferable are cyan couplers of the following formulas: 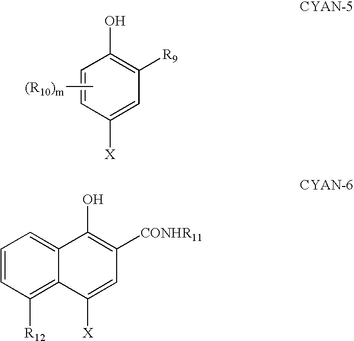
wherein R9 represents a substituent (preferably a carbamoyl, ureido, or carbonamido group), R10 represents a substituent (preferably individually selected from halogens, alkyl, and carbonamido groups), R11 represents ballast substituent, R12 represents a hydrogen or a substituent (preferably a carbonamido or sulphonamido group), X represents a hydrogen or a coupling-off group, and m is from 1-3.

A dissociative group has an acidic proton, for example, —NH—, —CH(R)—, that preferably has a pKa value of from 3 to 12 in water. Hammett's rule is an empirical rule proposed by L.P. Hammett in 1935 for the purpose of quantitatively discussing the influence of substituents on reactions or equilibria of a benzene derivative having the substituent thereon. This rule has become widely accepted. The values for Hammett's substituent constants can be found or measured as is described in the literature. For example, see C. Hansch and A. J. Leo, J. Med. Chem., 16, 1207 (1973); J. Med. Chem., 20, 304 (1977); and J. A. Dean, Lange's Handbook of Chemistry, 12th Ed. (1979) (McGraw-Hill).

Another type of preferred cyan coupler is an “NB coupler” which is a dye-forming coupler which is capable of coupling with the developer 4-amino-3-methyl-N-ethyl-N-(2-methanesulfonamidoethyl) aniline sesquisulfate hydrate to form a dye for which the left bandwidth (LBW) of its absorption spectra upon “spin coating” of a 3% w/v solution of the dye in di-n-butyl sebacate solvent is at least 5 nm. less than the LBW for a 3% w/v solution of the same dye in acetonitrile. The LBW of the spectral curve for a dye is the distance between the left side of the spectral curve and the wavelength of maximum absorption measured at a density of half the maximum.

The “spin coating” sample is prepared by first preparing a solution of the dye in di-n-butyl sebacate solvent (3% w/v). If the dye is insoluble, dissolution is achieved by the addition of some methylene chloride. The solution is filtered and 0.1-0.2 ml is applied to a clear polyethylene terephthalate support (approximately 4 cm×4 cm) and spun at 4,000 RPM using the Spin Coating equipment, Model No. EC101, available from Headway Research Inc., Garland Tex. The transmission spectra of the so prepared dye samples are then recorded.

Preferred “NB couplers” form a dye which, in n-butyl sebacate, has a LBW of the absorption spectra upon “spin coating” which is at least 15 nm, preferably at least 25 nm, less than that of the same dye in a 3% solution (w/v) in acetonitrile.

A cyan dye-forming “NB coupler” which may be useful in the invention has the formula (IA) 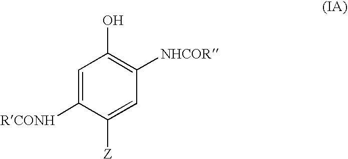
wherein
R′ and R″ are substituents selected such that the coupler is a “NB coupler”, as herein defined, and
Z is a hydrogen atom or a group which can be split off by the reaction of the coupler with an oxidized color developing agent.

The coupler of formula (IA) is a 2,5-diamido phenolic cyan coupler wherein the substituents R′ and R″ are preferably independently selected from unsubstituted or substituted alkyl, aryl, amino, alkoxy and heterocyclyl groups.

The “NB coupler” has the formula (I): 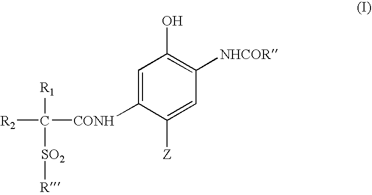
wherein
R″ and R′″ are independently selected from unsubstituted or substituted alkyl, aryl, amino, alkoxy and heterocyclyl groups and Z is as hereinbefore defined,
R1 and R2 are independently hydrogen or an unsubstituted or substituted alkyl group, and

Typically, R″ is an alkyl, amino or aryl group, suitably a phenyl group. R′″ is desirably an alkyl or aryl group or a 5- to 10-membered heterocyclic ring which contains one or more heteroatoms selected from nitrogen, oxygen and sulfur, which ring group is unsubstituted or substituted.

In the preferred embodiment the coupler of formula (I) may be a 2,5-diamido phenol in which the 5-amido moiety is an amide of a carboxylic acid which is substituted in the alpha position by a particular sulfone (—SO2-) group such as, for example, described in U.S. Pat. No. 5,686,235. The sulfone moiety is an unsubstituted or substituted alkylsulfone or a heterocyclyl sulfone or it is an arylsulfone, which is preferably substituted, in particular in the meta and/or para position.

Couplers having these structures of formulae (I) or (IA) comprise cyan dye-forming “NB couplers” which form image dyes having very sharp-cutting dye hues on the short wavelength side of the absorption curves with absorption maxima (λmax) which are shifted hypsochromically and are generally in the range of 620-645 nm, which is ideally suited for producing excellent color reproduction and high color saturation in color photographic papers.

Referring to formula (I), R1 and R2 are independently hydrogen or an unsubstituted or substituted alkyl group, preferably having from 1 to 24 carbon atoms and, in particular, 1 to 10 carbon atoms, suitably a methyl, ethyl, n-propyl, isopropyl, butyl or decyl group or an alkyl group substituted with one or more fluoro, chloro or bromo atoms, such as a trifluoromethyl group. Suitably, at least one of R1 and R2 is a hydrogen atom, and if only one of R1 and R2 is a hydrogen atom, then the other is preferably an alkyl group having 1 to 4 carbon atoms, more preferably 1 to 3 carbon atoms, and desirably two carbon atoms.

As used herein and throughout the specification unless where specifically stated otherwise, the term “alkyl” refers to an unsaturated or saturated straight or branched chain alkyl group, including alkenyl, and includes aralkyl and cyclic alkyl groups, including cycloalkenyl, having 3-8 carbon atoms and the term ‘aryl’ includes specifically fused aryl.

In formula (I), R″ is suitably an unsubstituted or substituted amino, alkyl or aryl group or a 5- to 10-membered heterocyclic ring which contains one or more heteroatoms selected from nitrogen, oxygen and sulfur, which ring is unsubstituted or substituted, but is more suitably an unsubstituted or substituted phenyl group.

Examples of suitable substituent groups for this aryl or heterocyclic ring include cyano, chloro, fluoro, bromo, iodo, alkyl- or aryl-carbonyl, alkyl- or aryl-oxycarbonyl, carbonamido, alkyl- or aryl-carbonamido, alkyl- or aryl-sulfonyl, alkyl- or aryl-sulfonyloxy, alkyl- or aryl-oxysulfonyl, alkyl- or aryl-sulfoxide, alkyl- or aryl-sulfamoyl, alkyl- or aryl-sulfonamido, aryl, alkyl, alkoxy, aryloxy, nitro, alkyl- or aryl-ureido and alkyl- or aryl-carbamoyl groups, any of which may be further substituted. Preferred groups are halogen, cyano, alkoxycarbonyl, alkylsulfamoyl, alkyl-sulfonamido, alkylsulfonyl, carbamoyl, alkylcarbamoyl or alkylcarbonamido. Suitably, R″ is a 4-chlorophenyl, 3,4-di-chlorophenyl, 3,4-difluorophenyl, 4-cyanophenyl, 3-chloro-4-cyanophenyl, pentafluorophenyl, or a 3- or 4-sulfonamidophenyl group.

In formula (I) when R′″ is alkyl, it may be unsubstituted or substituted with a substituent such as halogen or alkoxy. When R′″ is aryl or a heterocycle, it may be substituted. Desirably, it is not substituted in the position alpha to the sulfonyl group.

In formula (I), when R′″ is a phenyl group, it may be substituted in the meta and/or para positions with 1 to 3 substituents independently selected from the group consisting of halogen, and unsubstituted or substituted alkyl, alkoxy, aryloxy, acyloxy, acylamino, alkyl- or aryl-sulfonyloxy, alkyl- or aryl-sulfamoyl, alkyl- or aryl-sulfamoylamino, alkyl- or aryl-sulfonamido, alkyl- or aryl-ureido, alkyl- or aryl-oxycarbonyl, alkyl- or aryl-oxy-carbonylamino and alkyl- or aryl-carbamoyl groups.

In particular, each substituent may be an alkyl group such as methyl, t-butyl, heptyl, dodecyl, pentadecyl, octadecyl or 1,1,2,2-tetramethylpropyl, an alkoxy group such as methoxy, t-butoxy, octyloxy, dodecyloxy, tetradecyloxy, hexadecyloxy or octadecyloxy, an aryloxy group such as phenoxy, 4-t-butylphenoxy or 4-dodecyl-phenoxy, an alkyl- or aryl-acyloxy group such as acetoxy or dodecanoyloxy, an alkyl- or aryl-acylamino group such as acetamido, hexadecanamido or benzamido, an alkyl- or aryl-sulfonyloxy group such as methyl-sulfonyloxy, dodecylsulfonyloxy or 4-methylphenyl-sulfonyloxy, an alkyl- or aryl-sulfamoyl-group such as N-butylsulfamoyl or N-4-t-butylphenylsulfamoyl, an alkyl- or aryl-sulfamoylamino group such as N-butyl-sulfamoylamino or N-4-t-butylphenylsulfamoyl-amino, an alkyl- or aryl-sulfonamido group such as methane-sulfonamido, hexadecanesulfonamido or 4-chlorophenyl-sulfonamido, an alkyl- or aryl-ureido group such as methylureido or phenylureido, an alkoxy- or aryloxy-carbonyl such as methoxycarbonyl or phenoxycarbonyl, an alkoxy- or aryloxy-carbonylamino group such as methoxy-carbonylamino or phenoxycarbonylamino, an alkyl- or aryl-carbamoyl group such as N-butylcarbamoyl or N-methyl-N-dodecylcarbamoyl, or a perfluoroalkyl group such as trifluoromethyl or heptafluoropropyl.

Suitably, the above substituent groups have 1 to 30 carbon atoms, more preferably 8 to 20 aliphatic carbon atoms. A desirable substituent is an alkyl group of 12 to 18 aliphatic carbon atoms such as dodecyl, pentadecyl or octadecyl or an alkoxy group with 8 to 18 aliphatic carbon atoms such as dodecyloxy and hexadecyloxy or a halogen such as a meta or para chloro group, carboxy or sulfonamido. Any such groups may contain interrupting heteroatoms such as oxygen to form, for example, polyalkylene oxides.

In formula (I) or (IA), Z is a hydrogen atom or a group which may be split off by the reaction of the coupler with an oxidized color developing agent, known in the photographic art as a ‘coupling-off group' and is preferably hydrogen, chloro, fluoro, substituted aryloxy or mercaptotetrazole, more preferably hydrogen or chloro.

The presence or absence of such groups determines the chemical equivalency of the coupler, that is, whether it is a 2-equivalent or 4-equivalent coupler, and its particular identity may modify the reactivity of the coupler. Such groups may advantageously affect the layer in which the coupler is coated, or other layers in the photographic recording material by performing, after release from the coupler, functions such as dye formation, dye hue adjustment, development acceleration or inhibition, bleach acceleration or inhibition, electron transfer facilitation, color correction.

Representative classes of such coupling-off groups include, for example, halogen, alkoxy, aryloxy, heterocyclyloxy, sulfonyloxy, acyloxy, acyl, heterocyclylsulfonamido, heterocyclylthio, benzothiazolyl, phosophonyloxy, alkylthio, arylthio, and arylazo. These coupling-off groups are described in the art, for example, in U.S. Pat. Nos. 2,455,169, 3,227,551, 3,432,521, 3,467,563, 3,617,291, 3,880,661, 4,052,212, and 4,134,766, and in U.K. Patent Nos. and published applications 1,466,728, 1,531,927, 1,533,039, 2,066,755A, and 2,017,704A. Halogen, alkoxy, and aryloxy groups are most suitable.

Examples of specific coupling-off groups are —Cl, —F, —Br, —SCN, —OCH3, —OC6H5, —OCH2C(═O)NHCH2CH2OH, —OCH2C(O)NHCH2CH2OCH3, —OCH2C(O)NHCH2CH2OC(═O)OCH3, —P(═O)(OC2H5)2, —SCH2CH2COOH,

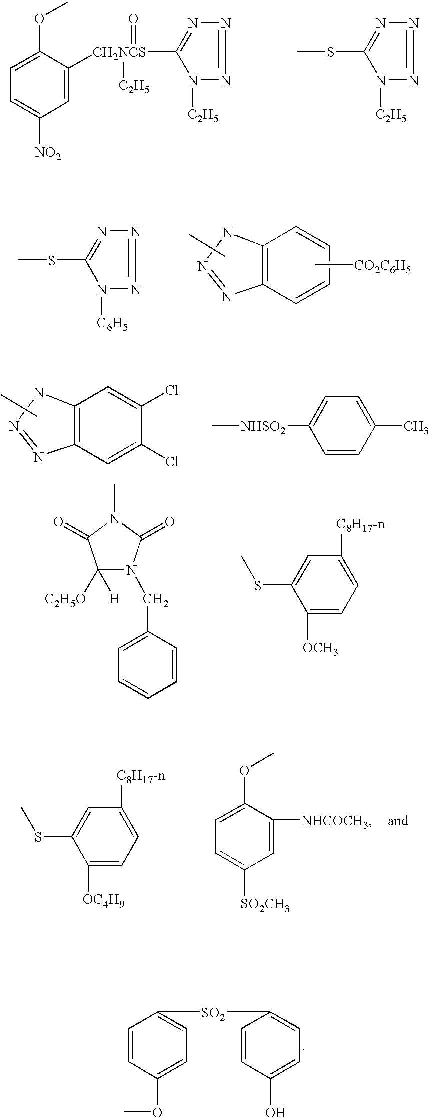

Typically, the coupling-off group is a chlorine atom, hydrogen atom, or p-methoxyphenoxy group.

It is essential that the substituent groups be selected so as to adequately ballast the coupler and the resulting dye in the organic solvent in which the coupler is dispersed. The ballasting may be accomplished by providing hydrophobic substituent groups in one or more of the substituent groups. Generally a ballast group is an organic radical of such size and configuration as to confer on the coupler molecule sufficient bulk and aqueous insolubility as to render the coupler substantially nondiffusible from the layer in which it is coated in a photographic element. Thus, the combination of substituent are suitably chosen to meet these criteria. To be effective, the ballast will usually contain at least 8 carbon atoms and typically contains 10 to 30 carbon atoms. Suitable ballasting may also be accomplished by providing a plurality of groups which, in combination, meet these criteria. In the preferred embodiments of the invention, R1 in formula (I) is a small alkyl group or hydrogen. Therefore, in these embodiments the ballast would be primarily located as part of the other groups. Furthermore, even if the coupling-off group Z contains a ballast, it is often desirable to ballast the other substituents as well, since Z is eliminated from the molecule upon coupling. Thus, the ballast is most advantageously provided as part of groups other than Z.

The following examples further illustrate preferred cyan couplers to be used with the invention. It is not to be construed that the present invention is limited to these examples.

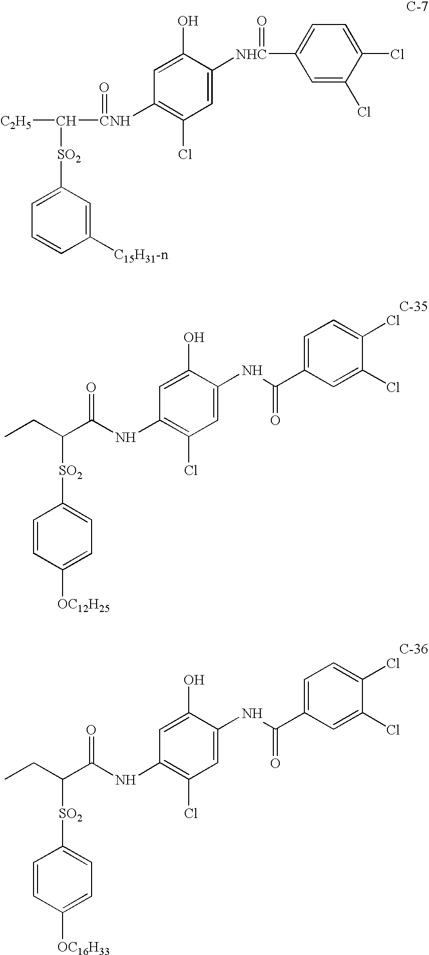

Preferred couplers are IC-7, IC-35, and IC-36 because of their suitably narrow left bandwidths.

Couplers that form magenta dyes upon reaction with oxidized color developing agent are described in such representative patents and publications as: U.S. Pat. Nos. 2,311,082, 2,343,703, 2,369,489, 2,600,788, 2,908,573, 3,062,653, 3,152,896, 3,519,429, 3,758,309, and “Farbkuppler-eine Literature Ubersicht,” published in Agfa Mitteilungen, Band III, pp. 126-156 (1961). Preferably such couplers are pyrazolones, pyrazolotriazoles, or pyrazolobenzimidazoles that form magenta dyes upon reaction with oxidized color developing agents. Especially preferred couplers are 1H-pyrazolo[5,1-c]-1,2,4-triazole and 1H-pyrazolo[1,5-b]-1,2,4-triazole. Examples of 1H-pyrazolo[5,1-c]-1,2,4-triazole couplers are described in U.K. Patent Nos. 1,247,493, 1,252,418, 1,398,979, U.S. Pat. Nos. 4,443,536, 4,514,490, 4,540,654, 4,590,153, 4,665,015, 4,822,730, 4,945,034, 5,017,465, and 5,023,170. Examples of 1H-pyrazolo[1,5-b]-1,2,4-triazoles can be found in European Patent applications 176,804, 177,765, U.S. Pat. Nos. 4,659,652, 5,066,575, and 5,250,400.

Typical pyrazoloazole and pyrazolone couplers are represented by the following formulas: 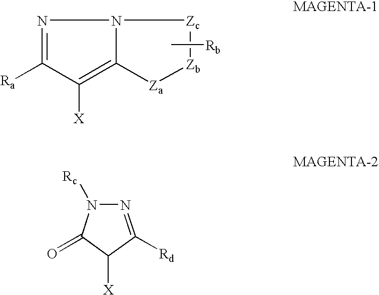
wherein Ra and Rb independently represent H or a substituent, Rc is a substituent (preferably an aryl group), Rd is a substituent (preferably an anilino, carbonamido, ureido, carbamoyl, alkoxy, aryloxycarbonyl, alkoxycarbonyl, or N-heterocyclic group), X is hydrogen or a coupling-off group, and Za, Zb, and Zc are independently a substituted methine group, ═N—, ═C—, or —NH—, provided that one of either the Za-Zb bond or the Zb-Zc bond is a double bond and the other is a single bond, and when the Zb-Zc bond is a carbon-carbon double bond, it may form part of an aromatic ring, and at least one of Za, Zb, and Zc represents a methine group connected to the group Rb.

Specific examples of such couplers are:

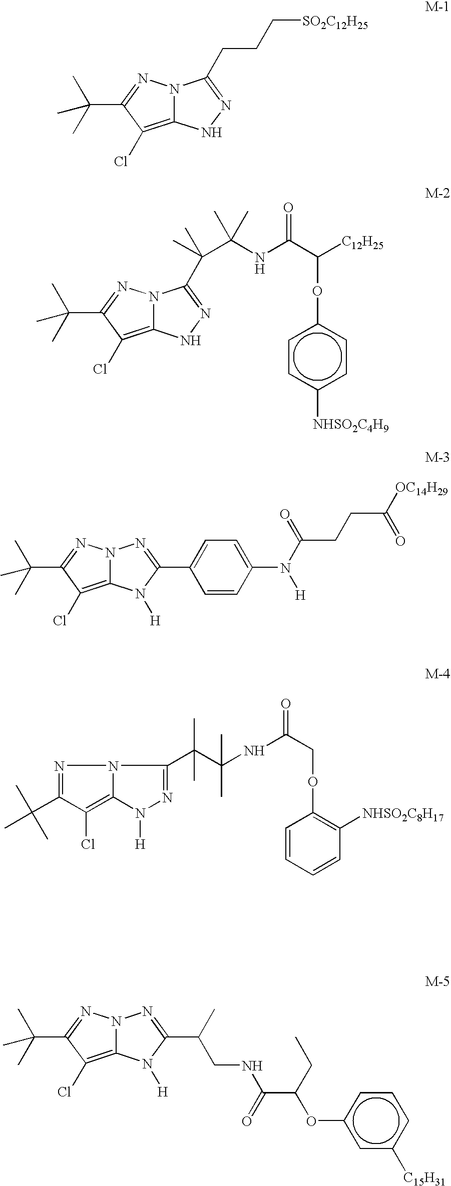

Couplers that form yellow dyes upon reaction with oxidized color developing agent are described in such representative patents and publications as: U.S. Pat. Nos. 2,298,443, 2,407,210, 2,875,057, 3,048,194, 3,265,506, 3,447,928, 3,960,570, 4,022,620, 4,443,536, 4,910,126, and 5,340,703 and “Farbkuppler-eine Literature Ubersicht,” published in Agfa Mitteilungen, Band III, pp. 112-126 (1961). Such couplers are typically open chain ketomethylene compounds. Also preferred are yellow couplers such as described in, for example, European Patent Application Nos. 482,552, 510,535, 524,540, 543,367, and U.S. Pat. No. 5,238,803. For improved color reproduction, couplers which give yellow dyes that cut off sharply on the long wavelength side are particularly preferred (for example, see U.S. Pat. No. 5,360,713).

Typical preferred yellow couplers are represented by the following formulas: 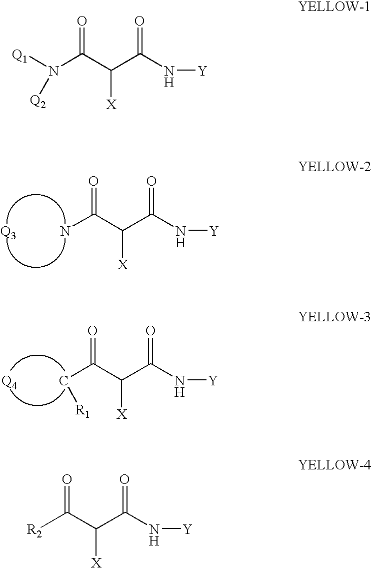
wherein R1, R2, Q1 and Q2 each represents a substituent, X is hydrogen or a coupling-off group, Y represents an aryl group or a heterocyclic group, Q3 represents an organic residue required to form a nitrogen-containing heterocyclic group together with the >N—, and Q4 represents nonmetallic atoms desired to from a 3- to 5-membered hydrocarbon ring or a 3- to 5-membered heterocyclic ring which contains at least one hetero atom selected from N, O, S, and P in the ring. Particularly preferred is when Q1 and Q2 each represents an alkyl group, an aryl group, or a heterocyclic group, and R2 represents an aryl or tertiary alkyl group.

Preferred yellow couplers may be of the following general structures:

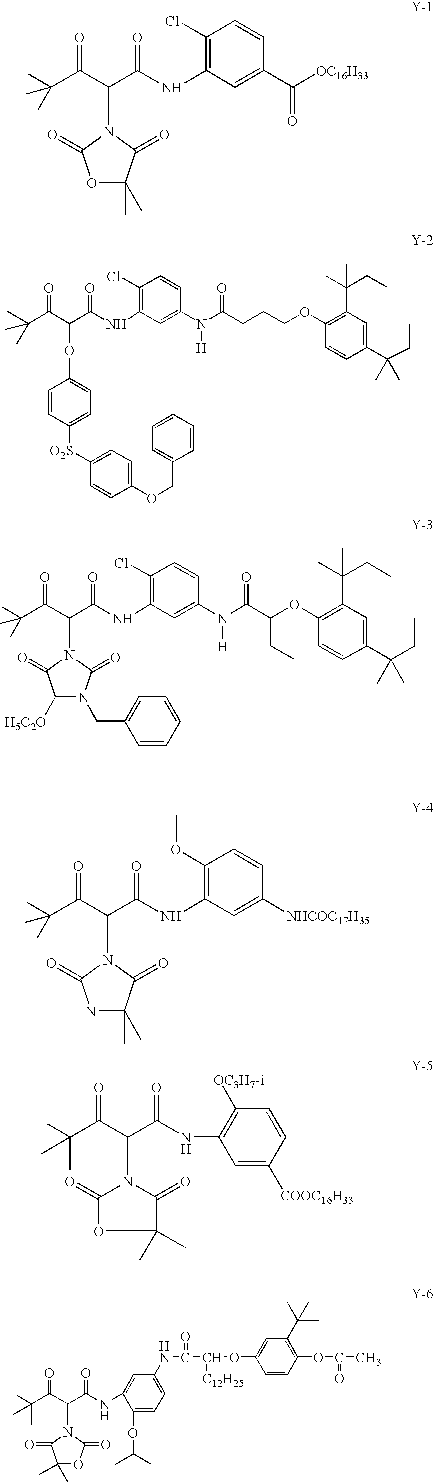

Unless otherwise specifically stated, substituent groups, which can be substituted on molecules herein include any groups, whether substituted or unsubstituted, which do not destroy properties desirable for photographic utility. When the term “group” is applied to the identification of a substituent containing a substitutable hydrogen, it is intended to encompass not only the substituent's unsubstituted form, but also its form further substituted with any group or groups as herein mentioned. Suitably, the group may be halogen or may be bonded to the remainder of the molecule by an atom of carbon, silicon, oxygen, nitrogen, phosphorous, or sulfur. The substituent may be, for example, halogen, such as chlorine, bromine or fluorine, nitro, hydroxyl, cyano, carboxyl, or groups which may be further substituted, such as alkyl, including straight or branched chain alkyl, such as methyl, trifluoromethyl, ethyl, t-butyl, 3-(2,4-di-t-pentylphenoxy) propyl, and tetradecyl, alkenyl, such as ethylene, 2-butene, alkoxy, such as methoxy, ethoxy, propoxy, butoxy, 2-methoxyethoxy, sec-butoxy, hexyloxy, 2-ethylhexyloxy, tetradecyloxy, 2-(2,4-di-t-pentylphenoxy)ethoxy, and 2-dodecyloxyethoxy, aryl such as phenyl, 4-t-butylphenyl, 2,4,6-trimethylphenyl, naphthyl, aryloxy, such as phenoxy, 2-methylphenoxy, alpha- or beta-naphthyloxy, and 4-tolyloxy, carbonamido, such as acetamido, benzamido, butyramido, tetradecanamido, alpha-(2,4-di-t-pentyl-phenoxy)acetamido, alpha-(2,4-di-t-pentylphenoxy)butyramido, alpha-(3-pentadecylphenoxy)-hexanamido, alpha-(4-hydroxy-3-t-butylphenoxy)-tetradecanamido, 2-oxo-pyrrolidin-1-yl, 2-oxo-5-tetradecylpyrrolin-1-yl, N-methyltetradecanamido, N-succinimido, N-phthalimido, 2,5-dioxo-1-oxazolidinyl, 3-dodecyl-2,5-dioxo-1-imidazolyl, and N-acetyl-N-dodecylamino, ethoxycarbonylamino, phenoxycarbonylamino, benzyloxycarbonylamino, hexadecyloxycarbonylamino, 2,4-di-t-butylphenoxycarbonylamino, phenylcarbonylamino, 2,5-(di-t-pentylphenyl)carbonylamino, p-dodecyl-phenylcarbonylamino, p-toluylcarbonylamino, N-methylureido, N,N-dimethylureido, N-methyl-N-dodecylureido, N-hexadecylureido, N,N-dioctadecylureido, N,N-dioctyl-N′-ethylureido, N-phenylureido, N,N-diphenylureido, N-phenyl-N-p-toluylureido, N-(m-hexadecylphenyl)ureido, N,N-(2,5-di-t-pentylphenyl)-N′-ethylureido, and t-butylcarbonamido, sulfonamido, such as methylsulfonamido, benzenesulfonamido, p-toluylsulfonamido, p-dodecylbenzenesulfonamido, N-methyltetradecylsulfonamido, N,N-dipropyl-sulfamoylamino, and hexadecylsulfonamido, sulfamoyl, such as N-methylsulfamoyl, N-ethylsulfamoyl, N,N-dipropylsulfamoyl, N-hexadecylsulfamoyl, N,N-dimethylsulfamoyl, N-[3-(dodecyloxy)propyl]sulfamoyl, N-[4-(2,4-di-t-pentylphenoxy)butyl]sulfamoyl, N-methyl-N-tetradecylsulfamoyl, and N-dodecylsulfamoyl, carbamoyl, such as N-methylcarbamoyl, N,N-dibutylcarbamoyl, N-octadecylcarbamoyl, N-[4-(2,4-di-t-pentylphenoxy)butyl]carbamoyl, N-methyl-N-tetradecylcarbamoyl, and N,N-dioctylcarbamoyl, acyl, such as acetyl, (2,4-di-t-amylphenoxy)acetyl, phenoxycarbonyl, p-dodecyloxyphenoxycarbonyl, methoxycarbonyl, butoxycarbonyl, tetradecyloxycarbonyl, ethoxycarbonyl, benzyloxycarbonyl, 3-pentadecyloxycarbonyl, and dodecyloxycarbonyl, sulfonyl, such as methoxysulfonyl, octyloxysulfonyl, tetradecyloxysulfonyl, 2-ethylhexyloxysulfonyl, phenoxysulfonyl, 2,4-di-t-pentylphenoxysulfonyl, methylsulfonyl, octylsulfonyl, 2-ethylhexylsulfonyl, dodecylsulfonyl, hexadecylsulfonyl, phenylsulfonyl, 4-nonylphenylsulfonyl, and p-toluylsulfonyl, sulfonyloxy, such as dodecylsulfonyloxy, and hexadecylsulfonyloxy, sulfinyl, such as methylsulfinyl, octylsulfinyl, 2-ethylhexylsulfinyl, dodecylsulfinyl, hexadecylsulfinyl, phenylsulfinyl, 4-nonylphenylsulfinyl, and p-toluylsulfinyl, thio, such as ethylthio, octylthio, benzylthio, tetradecylthio, 2-(2,4-di-t-pentylphenoxy)ethylthio, phenylthio, 2-butoxy-5-t-octylphenylthio, and p-tolylthio, acyloxy, such as acetyloxy, benzoyloxy, octadecanoyloxy, p-dodecylamidobenzoyloxy, N-phenylcarbamoyloxy, N-ethylcarbamoyloxy, and cyclohexylcarbonyloxy, amino, such as phenylanilino, 2-chloroanilino, diethylamino, dodecylamino, imino, such as 1 (N-phenylimido)ethyl, N-succinimido or 3-benzylhydantoinyl, phosphate, such as dimethylphosphate and ethylbutylphosphate, phosphite, such as diethyl and dihexylphosphite, a heterocyclic group, a heterocyclic oxy group or a heterocyclic thio group, each of which may be substituted and which contain a 3- to 7-membered heterocyclic ring composed of carbon atoms and at least one hetero atom selected from the group consisting of oxygen, nitrogen and sulfur, such as 2-furyl, 2-thienyl, 2-benzimidazolyloxy or 2-benzothiazolyl, quaternary ammonium, such as triethylammonium, and silyloxy, such as trimethylsilyloxy.

If desired, the substituents may themselves be further substituted one or more times with the described substituent groups. The particular substituents used may be selected by those skilled in the art to attain the desired photographic properties for a specific application and may include, for example, hydrophobic groups, solubilizing groups, blocking groups, releasing or releasable groups. Generally, the above groups and substituents thereof may include those having up to 48 carbon atoms, typically 1 to 36 carbon atoms and usually less than 24 carbon atoms, but greater numbers are possible depending on the particular substituents selected.

Representative substituents on ballast groups include alkyl, aryl, alkoxy, aryloxy, alkylthio, hydroxy, halogen, alkoxycarbonyl, aryloxcarbonyl, carboxy, acyl, acyloxy, amino, anilino, carbonamido, carbamoyl, alkylsulfonyl, arylsulfonyl, sulfonamido, and sulfamoyl groups wherein the substituents typically contain 1 to 42 carbon atoms. Such substituents may also be further substituted.

Stabilizers and scavengers that may be used with the present invention, but are not limited to, the following:

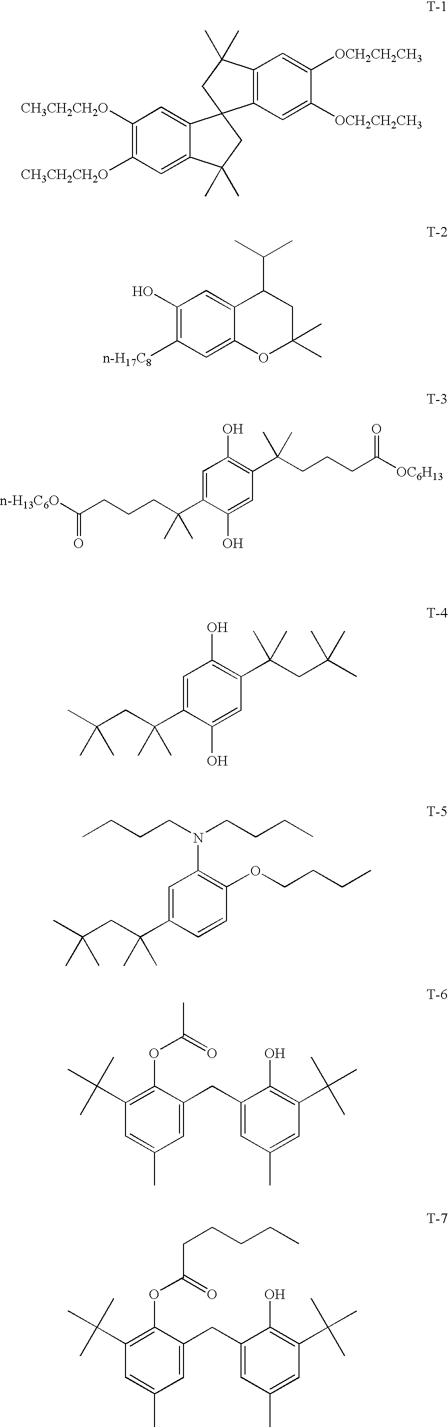

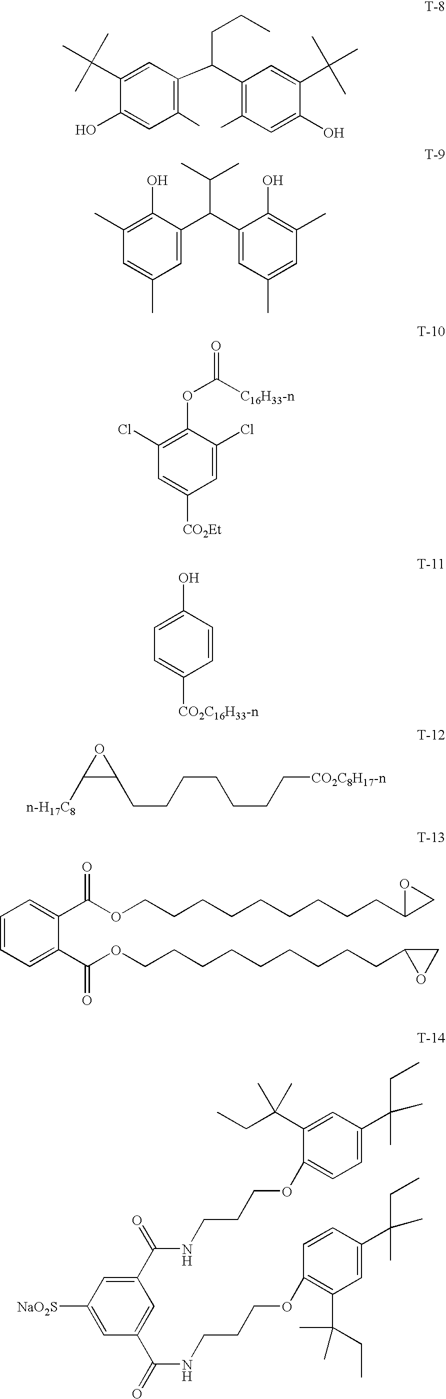

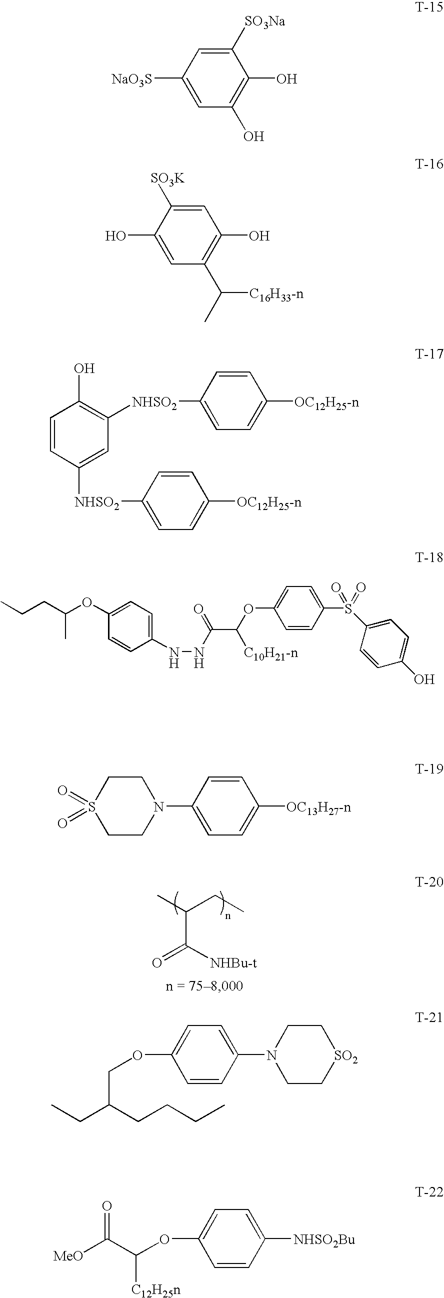

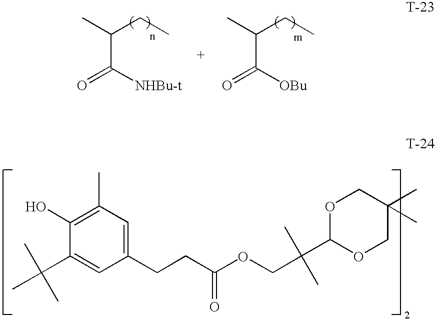

Examples of solvents which may be used in the invention include the following:

| | |
|---|---|
| Tritolyl phosphate | S-1 |
| Dibutyl phthalate | S-2 |
| Diundecyl phthalate | S-3 |
| N,N-Diethyldodecanamide | S-4 |
| N,N-Dibutyldodecanamide | S-5 |
| Tris(2-ethylhexyl)phosphate | S-6 |
| Acetyl tributyl citrate | S-7 |
| 2,4-Di-tert-pentylphenol | S-8 |
| 2-(2-Butoxyethoxy)ethyl acetate | S-9 |
| 1,4-Cyclohexyldimethylene bis(2-ethylhexanoate) | S-10 |

The dispersions used in photographic elements useful with the present invention may also include ultraviolet (UV) stabilizers and so-called liquid UV stabilizers such as described in U.S. Pat. Nos. 4,992,358, 4,975,360, and 4,587,346. Examples of UV stabilizers are shown below.

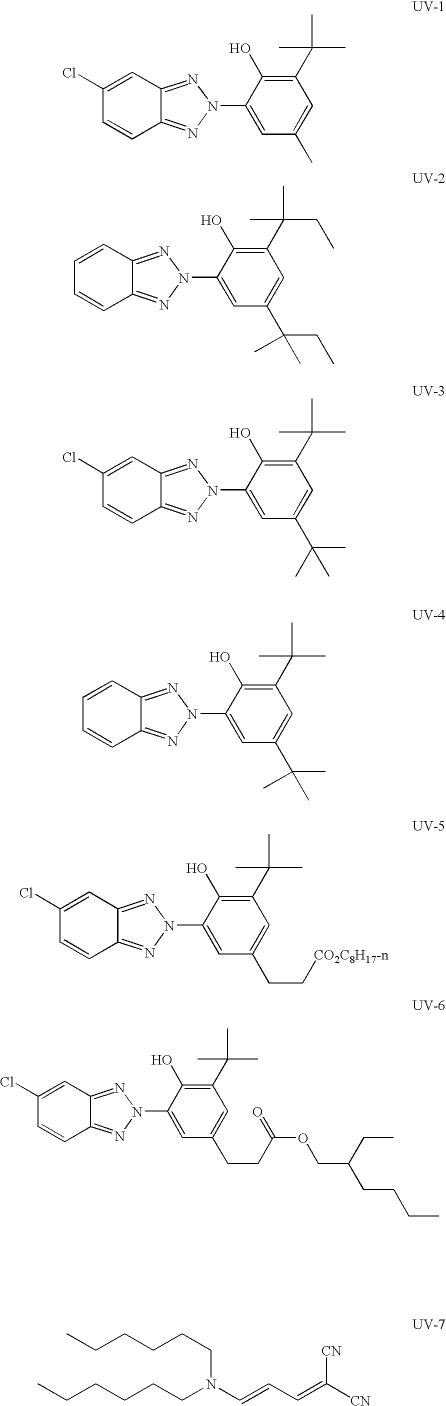

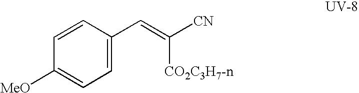

The aqueous phase may include surfactants. Surfactant may be cationic, anionic, zwitterionic or non-ionic. Useful surfactants include, but are not limited to, the following:

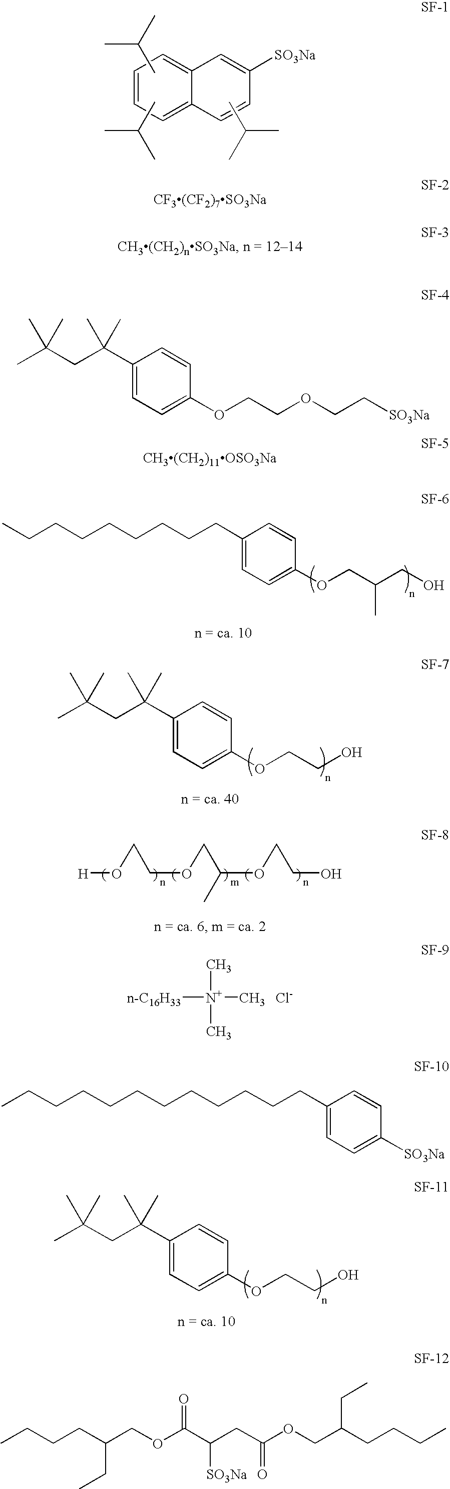

Further, it is contemplated to stabilize photographic dispersions prone to particle growth through the use of hydrophobic, photographically inert compounds such as disclosed by Zengerle et al U.S. Pat. 5,468,604.

Conventional features that may be incorporated into multilayer (and particularly multicolor) recording elements contemplated for use in the invention are illustrated by Research Disclosure, Item 38957, cited above:
XI. Layers and layer arrangements
XII. Features applicable only to color negative
XIII. Features applicable only to color positive
   B. Color reversal
   C. Color positives derived from color negatives
XIV. Scan facilitating features.

The recording elements comprising the radiation sensitive high chloride emulsion layers useful with this invention may be conventionally optically printed, or in accordance with a particular embodiment of the invention may be image-wise exposed in a pixel-by-pixel mode using suitable high energy radiation sources typically employed in electronic printing methods. Suitable actinic forms of energy encompass the ultraviolet, visible, and infrared regions of the electromagnetic spectrum, as well as electron-beam radiation and is conveniently supplied by beams from one or more light emitting diodes or lasers, including gaseous or solid state lasers. Exposures may be monochromatic, orthochromatic, or panchromatic. For example, when the recording element is a multilayer multicolor element, exposure may be provided by laser or light emitting diode beams of appropriate spectral radiation, for example, infrared, red, green or blue wavelengths, to which such element is sensitive. Multicolor elements may be employed which produce cyan, magenta and yellow dyes as a function of exposure in separate portions of the electromagnetic spectrum, including at least two portions of the infrared region, as disclosed in the previously mentioned U.S. Pat. No. 4,619,892. Suitable exposures include those up to 2000 nm, preferably up to 1500 nm. Suitable light emitting diodes and commercially available laser sources are known and commercially available. Imagewise exposures at ambient, elevated, or reduced temperatures and/or pressures may be employed within the useful response range of the recording element determined by conventional sensitometric techniques, as illustrated by T. H. James, The Theory of the Photographic Process, 4th Ed., Macmillan, 1977, Chapters 4, 6, 17, 18, and 23.

Once imagewise exposed, the recording elements may be processed in any convenient conventional manner to obtain a viewable image. Such processing is illustrated by Research Disclosure, Item 38957, cited above:
XVIII. Chemical development systems
XIX. Development
XX. Desilvering, washing, rinsing, and stabilizing

In addition, a useful developer for the inventive material is a homogeneous, single-part developing agent. The homogeneous, single-part color developing concentrate is prepared using a sequence of steps:

In the first step, an aqueous solution of a suitable color developing agent is prepared. This color developing agent is generally in the form of a sulfate salt. Other components of the solution may include an antioxidant for the color developing agent, a suitable number of alkali metal ions (in an at least stoichiometric proportion to the sulfate ions) provided by an alkali metal base, and a photographically inactive water-miscible or water-soluble hydroxy-containing organic solvent. This solvent is present in the final concentrate at a concentration such that the weight ratio of water to the organic solvent is from 15:85 to 50:50.

In this environment, especially at high alkalinity, alkali metal ions and sulfate ions form a sulfate salt that is precipitated in the presence of the hydroxy-containing organic solvent. The precipitated sulfate salt may then be readily removed using any suitable liquid/solid phase separation technique (including filtration, centrifugation, or decantation). If the antioxidant is a liquid organic compound, two phases may be formed and the precipitate may be removed by discarding the aqueous phase.

The color developing concentrates useful with this invention include one or more color developing agents that are well known in the art that, in oxidized form, will react with dye forming color couplers in the processed materials. Such color developing agents include, but are not limited to, aminophenols, p-phenylenediamines (especially N,N-dialkyl-p-phenylenediamines) and others which are well known in the art, such as EP 0 434 097 A1 (published Jun. 26, 1991) and EP 0 530 921 A1 (published Mar. 10, 1993). It may be useful for the color developing agents to have one or more water-solubilizing groups as are known in the art. Further details of such materials are provided in Research Disclosure, 38957, pages 592-639 (September 1996). Research Disclosure is a publication of Kenneth Mason Publications Ltd.; Dudley House, 12 North Street, Emsworth, Hampshire PO10 7DQ England (also available from Emsworth Design Inc., 121 West 19th Street, New York, N.Y. 10011). This reference will be referred to hereinafter as “Research Disclosure”.

Preferred color developing agents include, but are not limited to, N,N-diethyl p-phenylenediamine sulfate (KODAK Color Developing Agent CD-2), 4-amino-3-methyl-N-(2-methane sulfonamidoethyl)aniline sulfate, 4-(N-ethyl-N-□-hydroxyethylamino)-2-methylaniline sulfate (KODAK Color Developing Agent CD-4), p-hydroxyethylethylaminoaniline sulfate, 4-(N-ethyl-N-2-methanesulfonylaminoethyl)-2-methylphenylenediamine sesquisulfate (KODAK Color Developing Agent CD-3), 4-(N-ethyl-N-2-methanesulfonylaminoethyl)-2-methylphenylenediamine sesquisulfate, and others readily apparent to one skilled in the art.

In order to protect the color developing agents from oxidation, one or more antioxidants are generally included in the color developing compositions. Either inorganic or organic antioxidants may be used. Many classes of useful antioxidants are known, including but not limited to, sulfites (such as sodium sulfite, potassium sulfite, sodium bisulfite and potassium metabisulfite), hydroxylamine (and derivatives thereof), hydrazines, hydrazides, amino acids, ascorbic acid (and derivatives thereof), hydroxamic acids, aminoketones, mono- and polysaccharides, mono- and polyamines, quaternary ammonium salts, nitroxy radicals, alcohols, and oximes. Also useful as antioxidants are 1,4-cyclohexadiones. Mixtures of compounds from the same or different classes of antioxidants may also be used if desired.

Especially useful antioxidants are hydroxylamine derivatives as described, for example, in U.S. Pat. Nos. 4,892,804, 4,876,174, 5,354,646, and 5,660,974, all noted above, and U.S. Pat. No. 5,646,327 (Bums et al). Many of these antioxidants are mono- and dialkylhydroxylamines having one or more substituents on one or both alkyl groups. Particularly useful alkyl substituents include sulfo, carboxy, amino, sulfonamido, carbonamido, hydroxy, and other solubilizing substituents.

More preferably, the noted hydroxylamine derivatives may be mono- or dialkylhydroxylamines having one or more hydroxy substituents on the one or more alkyl groups. Representative compounds of this type are described, for example, in U.S. Pat. No. 5,709,982 (Marrese et al), as having the structure AI: 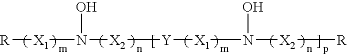
wherein R is hydrogen, a substituted or unsubstituted alkyl group of 1 to 10 carbon atoms, a substituted or unsubstituted hydroxyalkyl group of 1 to 10 carbon atoms, a substituted or unsubstituted cycloalkyl group of 5 to 10 carbon atoms, or a substituted or unsubstituted aryl group having 6 to 10 carbon atoms in the aromatic nucleus.

X1 is —CR2(OH)CHR1- and X2 is —CHR1CR2(OH)— wherein R1 and R2 are independently hydrogen, hydroxy, a substituted or unsubstituted alkyl group or 1 or 2 carbon atoms, a substituted or unsubstituted hydroxyalkyl group of 1 or 2 carbon atoms, or R1 and R2 together represent the carbon atoms necessary to complete a substituted or unsubstituted 5- to 8-membered saturated or unsaturated carbocyclic ring structure.

Y is a substituted or unsubstituted alkylene group having at least 4 carbon atoms, and has an even number of carbon atoms, or Y is a substituted or unsubstituted divalent aliphatic group having an even total number of carbon and oxygen atoms in the chain, provided that the aliphatic group has a least 4 atoms in the chain.

Also in Structure AI, m, n, and p are independently 0 or 1. Preferably, each of m and n is 1, and p is 0. Specific di-substituted hydroxylamine antioxidants include, but are not limited to, N,N-bis(2,3-dihydroxypropyl)-hydroxylamine, N,N-bis(2-methyl-2,3-dihydroxypropyl)hydroxylamine, and N,N-bis(1-hydroxymethyl-2-hydroxy-3-phenylpropyl)hydroxylamine. The first compound is preferred.

In the following Table, reference will be made to (1) Research Disclosure, December 1978, Item 17643, (2) Research Disclosure, December 1989, Item 308119, and (3) Research Disclosure, September 1994, Item 36544, all published by Kenneth Mason Publications, Ltd., Dudley Annex, 12a North Street, Emsworth, Hampshire PO 10 7DQ, ENGLAND. The Table and the references cited in the Table are to be read as describing particular components suitable for use with the invention. The Table and its cited references also describe suitable ways of preparing, exposing, processing and manipulating the elements, and the images contained therein.

| Reference | Section | Subject Matter |
|---|---|---|
| 1 | I, II | Grain composition, morphology |
| 2 | I, II, IX, X, XI, XII, | and preparation. Emulsion |
| | XIV, XV | preparation including hardeners, |
| | I, II, III, IX | coating aids, addenda, etc. |
| 3 | A & B | |
| 1 | III, IV | Chemical sensitization and |
| 2 | III, IV | spectral sensitization/ |
| 3 | IV, V | Desensitization |
| 1 | V | UV dyes, optical brighteners, |
| 2 | V | luminescent dyes |
| 3 | VI | |
| 1 | VI | Antifoggants and stabilizers |
| 2 | VI | |
| 3 | VII | |
| 1 | VIII | Absorbing and scattering |
| 2 | VIII, XIII, XVI | materials, Antistatic layers, |
| 3 | VIII, IX C & D | matting agents |
| 1 | VII | Image-couplers and image- |
| 2 | VII | modifying couplers, Dye |
| 3 | X | stabilizers and hue modifiers |
| 1 | XVII | Supports |
| 2 | XVII | |
| 3 | XV | |
| 3 | XI | Specific layer arrangements |
| 3 | XII, XIII | Negative working emulsions, |
| | | Direct positive emulsions |
| 2 | XVIII | Exposure |
| 3 | XVI | |
| 1 | XIX, XX | Chemical processing, |
| 2 | XIX, XX, XXII | Developing agents |
| 3 | XVIII, XIX, XX | |
| 3 | XIV | Scanning and digital processing |
| | | procedures |

The photographic elements may be exposed with various forms of energy which encompass the ultraviolet, visible, and infrared regions of the electromagnetic spectrum, as well as with electron beam, beta radiation, gamma radiation, x-ray, alpha particle, neutron radiation, and other forms of corpuscular and wave-like radiant energy in either noncoherent (random phase) forms or coherent (in phase) forms, as produced by lasers. When the photographic elements are intended to be exposed by x-rays, they may include features found in conventional radiographic element.

This allows for traditional image processing equipment to be used. The imaging elements of this invention may be exposed via traditional optical methods using a negative, but they are preferably exposed by means of a collimated beam, to form a latent image, and then processed to form a visible image, preferably by other than heat treatment. A collimated beam is preferred as it allows for digital printing and simultaneous exposure of the imaging layer on the top and bottom side without significant internal light scatter. A preferred example of a collimated beam is a laser also known as light amplification by stimulated emission of radiation. The laser may be preferred because this technology is used widely in a number of digital printing equipment types. Further, the laser provides sufficient energy to simultaneously expose the light sensitive silver halide coating on the top and bottom side of the display material of this invention without undesirable light scatter. Subsequent processing of the latent image into a visible image is preferably carried out in the known RA-4™ (Eastman Kodak Company) process or other processing systems suitable for developing high chloride emulsions.

### EXAMPLE

The following examples are provided to illustrate the invention.

Sample 1 (Control)

Sample 1 is representative of the prior art and is presented here for comparison purposes. A photographic paper raw base was made using a standard fourdrinier paper machine utilizing a blend of mostly bleached hardwood Kraft fibers. The fiber ratio consisted primarily of bleached poplar (38%)and maple/beech (37%) with lesser amounts of birch (18%) and softwood (7%). Acid sizing chemical addenda, utilized on a dry weight basis, included an aluminum stearate size at 0.85% addition, polyaminoamide epichlorhydrin at 0.68% addition, and polyacrylamide resin at 0.24% addition. Titanium dioxide filler was used at 0.60% addition. Surface sizing using hydroxyethylated starch and sodium bicarbonate was also employed. The raw base was then printed on the wire or backside with indicia. The printed raw base was then extrusion coated using a face side composite comprising substantially 83% LDPE, 12.5% titanium dioxide, 3% zinc oxide and 0.5% of calcium stearate and a wire side HDPE/LDPE blend at a 46/54 ratio. Resin coverages were approximately 27 g/m^{2.}

Sample 2 (Inventive)

This sample consists of an imaging element substrate with a front image side and a back non-image side and a donor web to apply indicia to the outer back most layer of the substrate. The imaging element substrate was a closed cell foam core coated with pigmented flange layers on each side. This sample consists of a receiver substrate, that is, the non-image side of an imaging element functioning as a receiver sheet, and a donor web to apply indicia to the outer back most layer of the substrate. The non-image side, which functioned as a receiver sheet of the element, was a closed cell foam core coated with pigmented flange layers on each side. A foamed core of polypropylene 100 μm thick and has a basis weight of 61.0 g/m 2 was melt extruded with a chemical blowing agent and solidified on a chill roller. The cast foam core was corona treated and then melt extruded with a talc and TiO2 filled polypropylene layer that was approximately 57 μm thick on the imaging and non imaging side.

The donor sheet used to transfer the indicia to the non-image side, which functioned as a receiver sheet of the element, was prepared by coating on a 6 μm poly(ethylene terephthalate) support with individual dye patches of cyan, magenta and yellow and a clear patch for environmental protection. The donor sheet was a thermal dye donor supplied by Eastman Kodak Company (Kodak Professional Thermal Transfer Ribbon V1.6) The printer used was a Kodak Professional Thermal Printer Model 8670PS.

Sample 3 (Inventive)

This sample was the same as Sample 2 except no environmental protection layer was placed over the indicia. The above examples were not coated with an imaging forming layer on the face or viewing side.

Sample 4 (Inventive)

This example is made the same as example 2 except that there is no environmental protection layer over the indicia on the backside. This example is used in non-photographic application and therefore the indicia on the backside is not exposed to high and low PH conditions. Indicia was successfully applied and was acceptable in appearance. In this case, the thermally transferred indicia does not necessarily require the additional environmental protection layer.

TABLE 1

| | PH 3 (60 sec) | PH 11 (60 sec) |
|---|---|---|
| | 6N HCL | 10% NaOH |
| | Delta Density | Delta Density |
| Example | (Before − after) | (Before − after) |
| Sample 1 (Control) | 0 | 0 |
| Print under | | |
| Polyethylene | | |
| Sample 2 (with | 0 | 0 |
| environmental | | |
| protection over | | |
| print) | | |
| Sample 3 (No | −0.1 | −0.09 |
| environmental over | | |
| print) | | |

Samples of the backside indicia printed imaging element were tested using concentrated HCL (6 normal solution) and NaOH (10%) solutions. A drop of solution was placed on the print area and allowed to stand for 60 seconds. The solution was then rubbed back and forth across the printed area with a nylon cloth using light pressure. A total of 10 wipes (5 in each direction) were made. The sample was rinsed with tap water and blotted dry. The printed density was measured before and after using and X-Rite densitometer Model 404. The visual density reading was used for this comparison.

As can be seen from the data in Table 1, the performance of an ink that is under a layer of polyethylene shows no loss in dye density before or after exposure. In the case of sample 2, that has the indicia has been transferred to the back polymer layer and then overcoated, there is no observable loss in dye density to either high or low PH conditions. Sample 3 experiences some dye density loss when exposed to different pH conditions. However, sample 3 still illustrates the ability to function as a receiver sheet by being able to achieve dye density.

The invention has been described in detail with particular reference to certain preferred embodiments thereof, but it will be understood that variations and modifications can be effected within the spirit and scope of the invention.

1. A method for placing indicia on the non-image side of a support for an imaging element comprising providing a support, wherein said imaging support comprises an image side having at least one imaging layer and a non-image side; contacting said non-image side of said support with a thermal transfer donating sheet; applying energy in a pattern to said thermal transfer dye donating sheet; and transferring said pattern to said non-image side of said support to form indicia.

2. The method of claim 1 wherein said thermal transfer donating sheet comprises at least one area containing dyes and at least one environmental protection laminate area.

3. The method of claim 2 wherein said environmental protection laminate area comprises ultraviolet absorbing materials.

4. The method of claim 3 wherein said ultraviolet absorbing materials is at least one member selected from the group consisting of ultraviolet absorbing dyes, ultraviolet absorbing pigments, ZnO and TiO₂.

5. The method of claim 2 wherein said environmental protection laminate area provides protection from photochemical materials.

6. The method of claim 5 wherein said photochemical material protection laminate area comprises at least one hydrophobic polymer.

7. The method of claim 6 wherein said hydrophobic polymer comprise at least one member selected from the group consisting of acrylate, acrylic, polystyrene, vinyl and copolymers thereof.

8. The method of claim 6 wherein said hydrophobic polymer comprises a blend of polyvinyl acetal and polyvinyl butyral.

9. The method of claim 5 wherein said photochemical material protection laminate area comprises colloid silica and UV absorbing material

10. The method of claim 2 wherein said environmental protection laminate area comprises abrasion protection materials.

11. The method of claim 10 wherein said abrasion protection materials comprise at least one material selected from the group consisting of silicas, microbeads, slip agents and fluoropolymers.

12. The method of claim 1 wherein said imaging support comprises paper.

13. The method of claim 12 wherein said paper comprises resin coated paper.

14. The method of claim 12 wherein said paper further comprises at least one biaxially oriented, voided sheet.

15. The method of claim 1 wherein said imaging support comprises a closed cell foam core sheet and adhered thereto an upper and lower polymer flange sheet, and wherein said closed cell foam core sheet comprises an expanded polymer and a blowing agent.

16. The method of claim 15 wherein at least one of said upper and lower polymer flange sheet comprises a biaxially oriented, voided sheet.

17. The method of claim 1 wherein said indicia comprise at least one member selected from the group consisting of letters, pictures, numbers, symbols, pattern and words.

18. The method of claim 1 wherein said energy comprises heat energy.

19. The method of claim 1 wherein said energy comprises laser energy.

20. The method of claim 1 wherein said imaging layer comprises photosensitive silver halide.

21. The method of claim 1 wherein said imaging layer comprises an inkjet imaging layer.

22. The method of claim 1 wherein said imaging layer comprises a thermal imaging layer.

23. The method of claim 1 wherein said imaging layer comprises an electrophotographic imaging layer.

24. The method of claim 1 wherein said support further comprises functional layers.

25. The method of claim 24 wherein said functional layers comprise at least one member selected from the group consisting of antistatic layer, release layer, friction control layer, dye receiving layer.

26. The method of claim 1 further comprising applying an environmental protection laminate layer to said non-image side of said support.
